(19) United States
(12) Patent Application Publication
(10) Pub. No.: US 2025/0111321 A1
(43) Pub. Date: Apr. 3, 2025

(54) SYSTEMS AND METHODS FOR PROVIDING DYNAMIC FLEET TRANSITION CLIMATE IMPACT REPORTS

(71) Applicant: Wells Fargo Bank, N.A., San Francisco, CA (US)

(72) Inventors: David Szmigielski, New York, NY (US); Patrick Friend, New York, NY (US)

(21) Appl. No.: 18/477,288

(22) Filed: Sep. 28, 2023

(51) Int. Cl. G06Q 10/0637; G06Q 10/0631; G06Q 30/018; G06Q 40/03

(52) U.S. Cl. CPC G06Q 10/06375; G06Q 10/06313; G06Q 30/018; G06Q 40/03

(57) ABSTRACT

Systems, apparatuses, methods, and computer program products are disclosed for generating a fleet transition climate impact report for an entity. An example method includes receiving a fleet transition climate impact report request and determining a current entity fleet metric set and a current vehicle estimate metric set. The example method further includes generating a recommended fleet electrification schedule. The example method further includes generating the fleet transition climate impact report and providing the fleet transition climate impact report.

### BACKGROUND

An entity may possess a vehicle fleet, which they rely on to accomplish entity-specific tasks and operations. Vehicles in this vehicle fleet may produce emissions and, therefore, may heavily contribute to the overall emissions profile of the entity.

### BRIEF SUMMARY

An entity's vehicle fleet may include vehicles having a variety of vehicle types and vehicle categories. The amount that a particular vehicle within the fleet contributes to an emissions profile of the entity depends on the particular vehicle type, vehicle category, overall usage, etc., of the vehicle. In general, vehicles are one of the largest contributors to an entity's emissions profile. Given the push to reduce emissions and desire for carbon-neutral emissions goals, entities may be incentivized to lower their emissions profile. Because an entity's vehicle fleet heavily influences the entity's emissions profile, it may be advantageous for the entity to replace vehicles that do not correspond to an electric vehicle category with vehicles with substantial emissions profile with a vehicle that has a lower emissions profile (e.g., replacing a vehicle having internal combustion engine with an electric vehicle). Evolving the entity's vehicle fleet in this fashion can aid the entity with achieving its goal of reducing its emission profile.

However, transitioning the vehicles within a vehicle fleet can be a complex task. First, this transition can be financially costly for the entity. While assistance, such as tax incentives, is often available, these incentives may be regionally specific and only available for certain vehicle types. As such, the entity may not be aware of these incentives or the extent to which they can use the incentives to facilitate a vehicle fleet transition. Additionally, the market for newer categories of vehicles (e.g., electric vehicles) is subject to disruptions and may not be equipped to handle large orders. Thus, it may be difficult to transition an entire vehicle fleet at once, and further, these market disruptions may even prevent entity plans for periodic vehicle transitions.

Example embodiments described herein may be used to generate a fleet transition climate impact report, which may be distributed to the entity and/or entity advisors. The fleet transition climate impact report may provide a recommended fleet electrification schedule, which the entity may follow to optimize their one or more emission target goals within a goal completion date. The recommended fleet electrification schedule may include one or more recommended fleet electrification events, which may each be associated with one or more recommended target fleet electrification goals and a recommended event time frame. Thus, the entity may follow the recommended fleet electrification events, which break down the overall emission target goals for the entity into smaller, attainable goals. Additionally, the recommended fleet electrification events may be determined based on a current entity fleet metric set, which is indicative of the vehicles currently associated with the entity, and a current vehicle estimate metric set, which is indicative of a various estimated values or metrics associated with a particular vehicle and/or vehicle categories. Thus, embodiments described herein may determine the one or more recommended fleet electrification events in a manner that is optimized for the specific entity and the entity's vehicle fleet. In some embodiments, the fleet transition climate impact report further includes one or more projection metrics, which may illustrate the impact on operational metrics for the entity in an instance in which a target fleet electrification goal is achieved. These projection metrics may thus highlight the specific benefits for the entity should they achieve the target fleet electrification goals described by a given recommended fleet electrification event. Additionally, one or more insights may be generated for the one or more recommended fleet electrification events. The one or more insights may provide an explanation of one or more recommended fleet electrifications events and/or an inferred cause for a target fleet electrification goal, recommended event time frame, and/or projection metrics associated with a given recommended fleet electrification event.

In some embodiments, the current entity fleet metric set may be determined based on a received entity fleet report. In some embodiments, historical entity fleet metric sets determined for the entity may be stored, such as in an entity look-up table. The historical entity fleet metric set may be accessed and used to determine the current entity fleet metric set. As such, the entity fleet report may only include information indicative of modifications to the entity's fleet, thereby reducing the amount of computational resources necessary to generate and process the entity fleet report as well as conserving network bandwidth. The historical entity fleet metric set may be updated using the entity fleet report to determine the current entity fleet metric set.

Additionally, embodiments described herein leverage available data sources to automatically determine vehicle parameter estimates included in a given current vehicle estimate set. The data sources may include entity reports or other trusted sources. As such, example embodiments are configured to determine vehicle parameter estimates using entity-specific data when available, but they may otherwise use publicly available data. While entity-specific data may yield more accurate vehicle parameter estimates, publicly available data may be used to supplement this entity-specific data to allow for a complete current vehicle estimate set.

Furthermore, in some embodiments, one or more recommended products may be determined for the entity. The one or more recommended products may correspond to vehicles determined to fit the criteria necessary to satisfy a target fleet electrification goal for a recommended fleet electrification event. The one or more recommended products may be included in the fleet transition climate impact report such that an end user may easily determine candidate vehicles to add to the entity's vehicle fleet.

Additionally, the insight report may include one or more implementation service offers. An implementation service offer may offer financial assistance or other resource assistance for the entity to aid the entity with implementing one or more changes, updates, modifications, etc., to the entity's vehicle fleet. Thus, the implementation service offers included in the insight report may provide the entity with the resources required to purchase or lease vehicles that may aid the entity with attaining the one or more target fleet electrification goals for a given recommended fleet electrification event.

Additionally, embodiments described herein may leverage parallel processing to simultaneously process various inputs and generate various outputs. For example, determining a vehicle category for one or more identified vehicles, determining one or more vehicle parameter estimates, generating recommended fleet electrification events, etc., may be performed simultaneously through the use of multiple sets of computing infrastructure, which would enable a reduction in the runtime for these various operations, and in some implementations allow the evaluation of multiple scenarios at once, which can enhance overall operational planning processes and ensure that the output information is up-to-date and accurate. The use of enhanced computing infrastructure in this fashion may be of particular importance when performing operations for an entity with a large number of vehicles in its vehicle fleet.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating and provides a fleet transition climate impact report.

FIG. 2 illustrates a schematic block diagram of example circuitry embodying a system device that may perform various operations, in accordance with some example embodiments described herein.

FIG. 3 illustrates an example flowchart for generating and providing a fleet transition climate impact report, in accordance with some example embodiments described herein.

FIG. 4 illustrates an example flowchart for determining a current entity fleet metric set, in accordance with some example embodiments described herein.

FIG. 5 illustrates an example flowchart for determining a current vehicle estimate metric set, in accordance with some example embodiments described herein.

FIG. 6 illustrates an example flowchart for determining one or more predicted inventory events based on one or more predicted inventory events, in accordance with some example embodiments described herein.

FIG. 7 illustrates an example flowchart for generating and providing one or more implementation service offers, in accordance with some example embodiments described herein.

FIGS. 8A, 8B, 8C, 8D, 8E, 8F, 8G, and 8H illustrate example user interfaces depicting example fleet transition climate impact reports, as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” or “device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

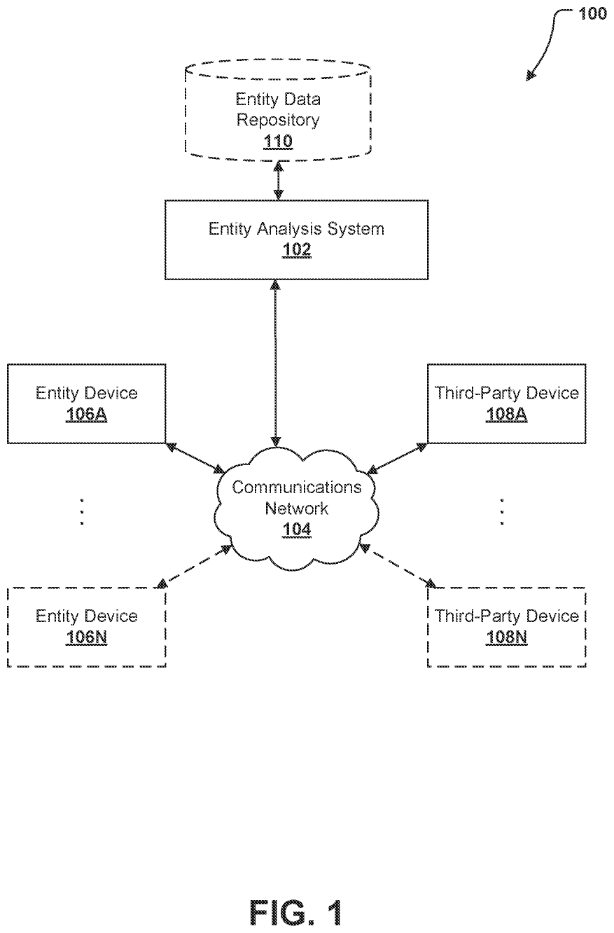

Example embodiments described herein may be implemented using any of a variety of computing devices or servers. To this end, FIG. 1 illustrates an example environment 100 within which various embodiments may operate. As illustrated, the entity analysis system 102 may receive and/or transmit information via communications network 104 (e.g., the Internet) with any number of other devices, such as one or more of entity devices 106A-106N and/or third-party devices 108A-108N.

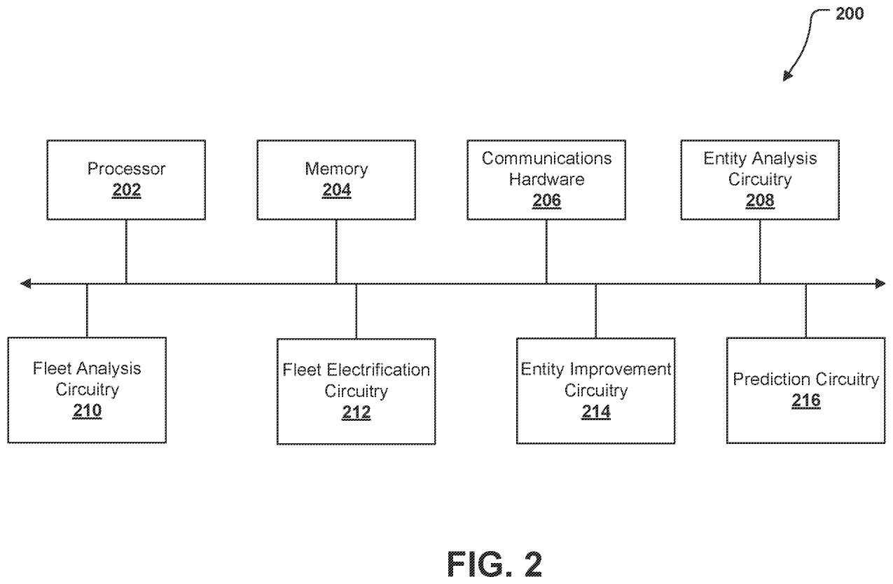

The entity analysis system 102 may be implemented as one or more computing devices or servers, which may be composed of a series of components. Particular components of the entity analysis system 102 are described in greater detail below with reference to apparatus 200 in connection with FIG. 2.

In some embodiments, the entity analysis system 102 further includes an entity data repository 110 that comprises a distinct component from other components of the entity analysis system 102. The entity data repository 110 may be embodied as one or more direct-attached storage (DAS) devices (such as hard drives, solid-state drives, optical disc drives, or the like) or may alternatively comprise one or more network attached storage (NAS) devices independently connected to a communications network (e.g., communications network 104). The entity data repository 110 may host the software executed to operate the entity analysis system 102. The entity data repository 110 may store information relied upon during operation of the entity analysis system 102, such as various machine-learning models or other models that may be used by the entity analysis system 102, data and documents to be analyzed using the entity analysis system 102, or the like. In addition, entity data repository 110 may store control signals, device characteristics, and access credentials enabling interaction between the entity analysis system 102 and one or more of the entity devices 106A-106N or third-party devices 108A-108N.

The one or more entity devices 106A-106N and the one or more third-party devices 108A-108N may be embodied by any computing devices known in the art. The one or more entity devices 106A-106N and the one or more third-party devices 108A-108N need not themselves be independent devices, but they may be peripheral devices communicatively coupled to other computing devices. In some embodiments, the one or more entity devices 106A-106N may be associated with the entity for which the fleet transition climate impact report is being generated. In some embodiments, the one or more entity devices 106A-106N may be configured to provide the entity analysis system 102 with entity data, such as an entity fleet report. The one or more entity devices 106A-106N may additionally be configured to receive user input from authorized entity users (e.g., employers, administrators, managers) and, in response, provide the entity analysis system 102 with a fleet transition climate impact report request and/or the like. In some embodiments, the one or more third-party device 108A-108N may be associated with a particular entity. For example, third-party devices 108A-108C may be associated with a first data vendor and third-party devices 108D-108E may be associated with a second data vendor.

Although FIG. 1 illustrates an environment and implementation in which the entity analysis system 102 interacts indirectly with a user via one or more entity devices 106A-106N and/or third-party devices 108A-108N, in some embodiments users may directly interact with the entity analysis system 102 (e.g., via communications hardware of the entity analysis system 102), in which case separate entity devices 106A-106N and/or third-party devices 108A-108N may not be utilized. Whether by way of direct interaction or indirect interaction via another device, a user may communicate with, operate, control, modify, or otherwise interact with the entity analysis system 102 to perform the various functions and achieve the various benefits described herein.

### Example Implementing Apparatuses

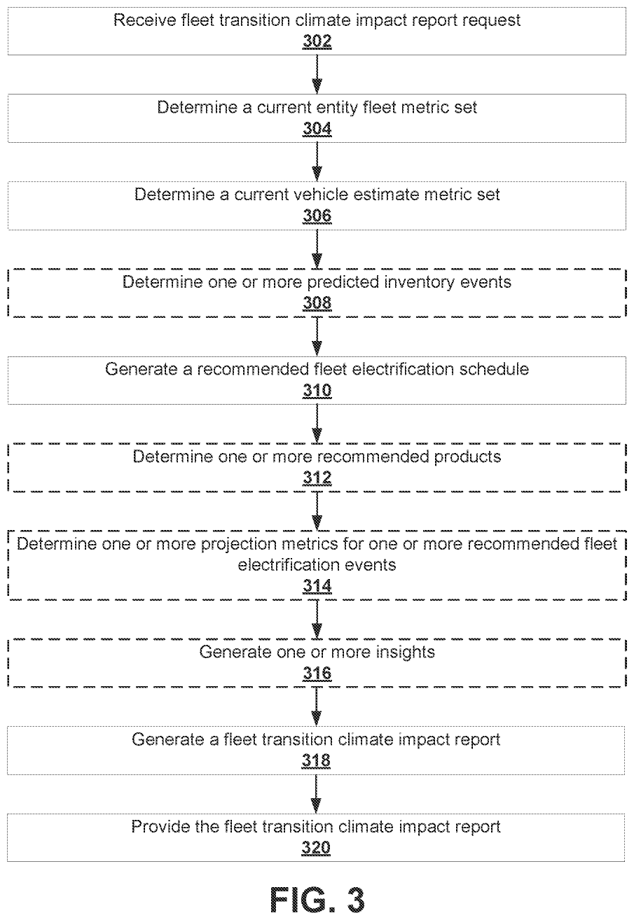

The entity analysis system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include a processor 202, memory 204, communications hardware 206, entity analysis circuitry 208, fleet analysis circuitry 210, fleet electrification circuitry 212, entity improvement circuitry 214, and prediction circuitry 216, each of which will be described in greater detail below.

The processor 202 (and/or co-processor or any other processor assisting or otherwise associated with the processor) may be in communication with the memory 204 via a bus for passing information among components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like, for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

The apparatus 200 further comprises entity analysis circuitry 208 that may be configured to determine a current entity fleet metric set for an entity. In some embodiments, the entity analysis circuitry 208 may further be configured to identify one or more vehicles associated with the entity and/or determine a vehicle category for one or more identified vehicles. The entity analysis circuitry 208 may utilize processor 202, memory 204, or any other hardware component included in the apparatus 200 to perform these operations, as described in connection with FIGS. 3-7 below. The entity analysis circuitry 208 may further utilize communications hardware 206 to gather data from a variety of sources (e.g., entity devices 106A-106N, third-party devices 108A-108N, and/or entity data repository 110, as shown in FIG. 1), and/or exchange data with a user, and in some embodiments may utilize processor 202 and/or memory 204.

The apparatus 200 further comprises fleet analysis circuitry 210 that may be configured to determine a current vehicle estimate metric set. In some embodiments, the fleet analysis circuitry 210 may further be configured to extract vehicle information from one or more data sources and/or determine one or more vehicle parameter estimates. The fleet analysis circuitry 210 may utilize processor 202, memory 204, or any other hardware component included in the apparatus 200 to perform these operations, as described in connection with FIGS. 3-7 below. The fleet analysis circuitry 210 may further utilize communications hardware 206 to gather data from a variety of sources (e.g., entity devices 106A-106N, third-party devices 108A-108N, and/or entity data repository 110, as shown in FIG. 1), and/or exchange data with a user, and in some embodiments may utilize processor 202 and/or memory 204.

The apparatus 200 further comprises fleet electrification circuitry 212 that may be configured to generate a recommended fleet electrification schedule and generate a fleet transition climate impact report. In some embodiments, the fleet electrification circuitry 212 may further be configured to determine one or more projection metrics and/or determine one or more recommended products. The fleet electrification circuitry 212 may utilize processor 202, memory 204, or any other hardware component included in the apparatus 200 to perform these operations, as described in connection with FIGS. 3-7 below. The fleet electrification circuitry 212 may further utilize communications hardware 206 to gather data from a variety of sources (e.g., entity devices 106A-106N, third-party devices 108A-108N, and/or entity data repository 110, as shown in FIG. 1), and/or exchange data with a user, and in some embodiments may utilize processor 202 and/or memory 204.

The apparatus 200 further comprises entity improvement circuitry 214 that may be configured to determine an implementation cost for one or more recommended fleet electrification events and/or generate one or more implementation service offers. The entity improvement circuitry 214 may utilize processor 202, memory 204, or any other hardware component included in the apparatus 200 to perform these operations, as described in connection with FIGS. 3-7 below. The entity improvement circuitry 214 may further utilize communications hardware 206 to gather data from a variety of sources (e.g., entity devices 106A-106N, third-party devices 108A-108N, and/or entity data repository 110, as shown in FIG. 1), and/or exchange data with a user, and in some embodiments may utilize processor 202 and/or memory 204.

The apparatus 200 further comprises prediction circuitry 216 that may be configured to determine one or more predicted inventory events, determine one or more predicted fleet electrification external events, and determine one or more predicted inventory values for a vehicle category. The prediction circuitry 216 may utilize processor 202, memory 204, or any other hardware component included in the apparatus 200 to perform these operations, as described in connection with FIGS. 3-7 below. The prediction circuitry 216 may further utilize communications hardware 206 to gather data from a variety of sources (e.g., entity devices 106A-106N, third-party devices 108A-108N, and/or entity data repository 110, as shown in FIG. 1), and/or exchange data with a user, and in some embodiments may utilize processor 202 and/or memory 204.

Although components 202-216 are described in part using functional language, it will be understood that the particular implementations necessarily include the use of particular hardware. It should also be understood that certain of these components 202-216 may include similar or common hardware. For example, entity analysis circuitry 208, fleet analysis circuitry 210, fleet electrification circuitry 212, entity improvement circuitry 214, and/or prediction circuitry 216 may each at times leverage use of processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus 200 therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the entity analysis circuitry 208, fleet analysis circuitry 210, fleet electrification circuitry 212, entity improvement circuitry 214, and prediction circuitry 216 may leverage processor 202, memory 204, or communications hardware 206 as described above, it will be understood that any of entity analysis circuitry 208, fleet analysis circuitry 210, fleet electrification circuitry 212, entity improvement circuitry 214, and prediction circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204) or communications hardware 206 for enabling any functions not performed by special-purpose hardware. In all embodiments, however, it will be understood that entity analysis circuitry 208, fleet analysis circuitry 210, fleet electrification circuitry 212, entity improvement circuitry 214, and prediction circuitry 216 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of the apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non- transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces (GUIs) and flowcharts.

### Example Operations

Turning to FIGS. 3-7, example flowcharts are illustrated that contain example operations implemented by example embodiments described herein. The operations illustrated in FIGS. 3-7 may, for example, be performed by system device of the entity analysis system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, entity analysis circuitry 208, fleet analysis circuitry 210, fleet electrification circuitry 212, entity improvement circuitry 214, prediction circuitry 216, and/or any combination thereof. It will be understood that user interaction with the entity analysis system 102 may occur directly via communications hardware 206, or may instead be facilitated by a separate device, which may have similar or equivalent physical componentry facilitating such user interaction.

Turning first to FIG. 3, example operations are shown for generating and providing a fleet transition climate impact report.

As shown by operation 302, the apparatus 200 includes means, such as processor 202, memory 204, communications hardware 206, entity analysis circuitry 208, and/or the like, for receiving a fleet transition climate impact report request. In some embodiments, communications hardware 206 may receive a fleet transition climate impact report request from an entity device, such as any one of entity devices 106A-106N. Receipt of the fleet transition climate impact report request may trigger apparatus 200 to perform one or more subsequent operations (e.g., operations 304-320) to generate and provide a fleet transition climate impact report to the requesting device (e.g., entity device 106A-106N) and/or other devices.

The fleet transition climate impact report request may be indicative of a request for a fleet transition climate impact report to be generated for a particular entity and/or a requesting entity. The fleet transition climate impact report request may be indicative of one or more emission target goals. Each emission target goal may also be associated with a goal completion date. The one or more emission target goals may be indicative of a desired emissions goal for the entity to achieve by the goal completion date. For example, an emission target goal may be for the entity to become carbon neutral by 2035 (e.g., the associated goal completion date). In some embodiments, the fleet transition climate impact report may further include a preferred pace selected by the entity. The preferred pace may describe a pacing for recommended fleet electrification events. For example, a preferred pace may be a non-linear pace and the entity may further specify the particular pacing to be 15% within four years, 35% within the following four years (e.g., for a total of 50% completion), and the final 50% within the next four years. The preferred pace may allow for entities to plan ahead and accommodate other entity events and/or budgetary restrictions within a particular time frame.

The fleet transition climate impact report may include an indication of the entity requesting the fleet transition climate impact report. For example, the fleet transition climate impact report request may include an indication of an entity, such as an entity name (e.g., “Company [XXX]”), entity domain indicator (e.g., email domain, html domain, entity website), entity device indicator (e.g., media access control (MAC) address, phone number, serial number, international mobile equipment identity (IMEI) number, etc.), an entity identifier, and/or the like.

In some embodiments, apparatus 200 may use an entity look-up table to identify a requesting entity and/or entity to which the fleet transition climate impact report request pertains to. The entity look-up table may be stored in an associated memory, such as memory 204, entity data repository 110, or another storage location. The entity analysis circuitry 208 may be configured to use the entity indication provided in the fleet transition climate impact report request to query the entity look-up table for the corresponding entity. The entity look-up table may include one or more entity identifiers, which each uniquely identify each entity. Each entity identifier may further be associated with one or more entity indicators such that the entity analysis circuitry 208 may use provided identity indicators to identify the entity identifier for the entity. Each entity identifier may further be associated with entity data, such as a current and/or historical entity fleet metrics set, a current and/or historical vehicle estimate metric set, historical recommended fleet electrification schedules, historical recommended products, historical projection metrics for historical recommended fleet electrification events, historical fleet transition climate impact reports, historical implementation service offers, historical received requests and/or responses (e.g., received fleet transition climate impact report requests and/or fleet transition climate impact reports), and/or the like. The entity data associated with the entity identifier stored in the entity look-up table may be updated and/or managed by the entity analysis circuitry 208 such that the entity data reflects up-to-date and accurate information for the corresponding entity.

The entity identifier may further be associated with one or more authorized communication channels, entities, users, parties, and/or devices, which may provide apparatus 200 with instructions for providing a response to a received request. For example, the entity identifier may be associated with entity devices 106A-106N and third-party devices 108A-108C. Entity devices 106A-106N and third-party devices 108A-108C may be associated with permissions for receiving a fleet transition climate impact report request, but only entity devices 106A-106N may be associated with permission for receiving additional responses (e.g., implementation service offers). As another example, the entity identifier may be associated with certain user credentials such that these user credentials must be provided in the fleet transition climate impact report request prior to apparatus 200 generating a response. In an instance in which an entity, user, party, device, etc., provides a request for a response that it does not have permissions for, entity analysis circuitry 208 may use communications hardware 206 to provide an unauthorized access message to the requesting entity, user, party, device, etc., indicative that this information is not accessible.

In some embodiments, the query of the entity look-up table using the entity indicators provided in the fleet transition climate impact report request may return empty query results. This may be due to the entity not currently having an entry and entity identifier in the entity look-up table. In some embodiments, receipt of empty query results may cause the entity analysis circuitry 208 to generate a new entity identifier for the entity described by the fleet transition climate impact report request and associate the provided entity indicators with the entity identifier. In some embodiments, the entity analysis circuitry 208 may request an authorized user (e.g., a user associated with the entity analysis system 102) to manually review the new entity identifier and provide an indication of authorized communication channels, entities, users, parties, and/or devices and permissions prior to proceeding. Alternatively, the entity analysis circuitry 208 may proceed with subsequent operations and take additional action prior to providing responses to a requesting entity or device. For example, the entity analysis circuitry 208 may provide the generated fleet transition climate impact report to a user or device associated with the entity analysis system 102 prior to providing the fleet transition climate impact report to other devices (e.g., entity devices 106A-106N and/or third-party devices 108A-108N).

As shown by operation 304, the apparatus 200 includes means, such as processor 202, memory 204, communications hardware 206, entity analysis circuitry 208, fleet analysis circuitry 210, and/or the like, for determining a current entity fleet metric set. A current entity fleet metric set may include one or more vehicles that are determined to be associated with the entity. In some embodiments, each vehicle may be associated with a unique vehicle identifier. In some embodiments, a vehicle identifier may correspond to a vehicle identification number (VIN), hull identification number (HUL), registration number, identification number, and/or the like. Each vehicle may be associated with a vehicle type and/or a vehicle category. A vehicle type may be indicative of the type of vehicle the vehicle corresponds to. For example, vehicle types may include passenger cars, sport utility vehicles (SUVs), hatchbacks, crossovers, convertibles, sedans, sports cars, coupes, minivans, pickup trucks, cargo vans, commercial trucks, box trucks, minibuses, buses, semi-trailer trucks, boats, yachts, planes, trains, recreational vehicles, drones, etc. The vehicle category may be indicative of a category the particular vehicle falls within as defined by certain regulatory bodies. For example, vehicle categories may include light duty vehicles, medium duty vehicles, light light duty vehicles, heavy light duty vehicles, heavy duty vehicles, light heavy duty diesel vehicles, medium heavy duty diesel vehicles, heavy heavy duty vehicles, medium duty passenger vehicles, light duty trucks, electric light duty vehicles, electric medium duty vehicles, electric light light duty vehicles, electric heavy light duty vehicles, electric heavy duty vehicles, hybrid light duty vehicles, hybrid medium duty vehicles, hybrid light light duty vehicles, hybrid heavy light duty vehicles, hybrid heavy duty vehicles, and/or the like. Additionally, in some embodiments a vehicle may be associated with one or more attributes, such as a color, make, model, manufacturing year, vehicle age, purchase date, purchase price, mileage, accident report, fuel usage, type of fuel used, annual depreciation rate, annual miles driven, miles driven to date, average miles per gallon measures, emissions measures, etc.

In some embodiments, an electric vehicle category may include vehicles other than traditional electric vehicles For example, an electric vehicle category may include vehicles with relatively lower emissions as compared to average emission vehicles. For example, the electric vehicle category may include hybrid vehicles, hydrogen fuel cell vehicles, and/or diesel vehicles.

In some embodiments, each vehicle in the current entity fleet metric set may also be associated with one or more vehicle statuses. A vehicle status may be indicative of the operational state of the vehicle and/or its association with the entity. For example, a vehicle status may include an operational status, a non-operational status, a needs maintenance status, an owned status, a sold status, a leased status, and/or the like. A vehicle may be associated with multiple vehicle statuses. For example, a vehicle may be associated with an owned status and an operational status, indicating the particular vehicle is owned by the entity and is currently operational.

The current entity fleet metric set may be indicative of an entity's current fleet profile as well as information regarding individual vehicles. Additional entity fleet information may be determined using the current entity fleet metric set. For example, the overall count of vehicles associated (e.g., including vehicles associated with any vehicle category), a current count of electric vehicles (e.g., including vehicles associated with any electric vehicle category), a current count of non-electric vehicles (e.g., including vehicles not associated with an electric vehicle category), a vehicle usage (e.g., catering, delivery, home services, construction, etc.), a vehicle location, an ownership status (e.g., leased or owned), and/or the like may be determined for the entity using the current entity fleet metric set.

In some embodiments, the current entity fleet metric set may be stored and

maintained in an associated memory, such as memory 204 and/or entity data repository 110. In some embodiments, the current entity fleet metric set may be associated with the corresponding entity identifier and stored in the entity look-up table. As such, the entity analysis circuitry 208 may determine the current entity fleet metric set by accessing the stored entity fleet metric set using the entity look-up table.

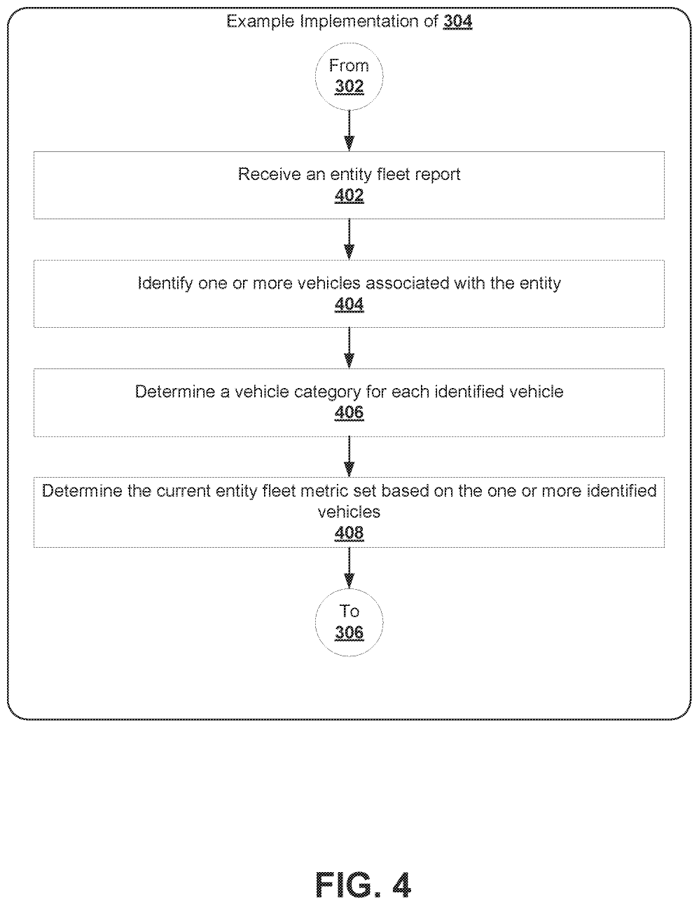

In some embodiments, operation 304 may be performed in accordance with the operations described by FIG. 4. Turning to FIG. 4, example operations are shown for determining the current entity fleet metric set based on one or more identified vehicles.

As shown by operation 402, the apparatus 200 includes means, such as processor 202, memory 204, communications hardware 206, and/or the like, for receiving an entity fleet report. In some embodiments, the entity fleet report may be included in the fleet transition climate impact report request such that the communications hardware 206 may receive the entity fleet report with the fleet transition climate impact report request. Alternatively, the communications hardware 206 may separately receive an entity fleet report from an entity device, such as any one of entity devices 106A-106N. In some embodiments, the communications hardware 206 may periodically or semi-periodically receive an entity fleet report. In some embodiments, the communications hardware 206 may receive the entity fleet report in an instance one or more modifications have been made in the entity fleet report (e.g., a new vehicle was purchased, a previous vehicle was sold or retired).

The entity fleet report may be indicative of the one or more vehicles currently associated with the entity. In some embodiments, the entity fleet report may further include the unique vehicle identifier, the vehicle type, the vehicle category, one or more vehicles statuses, and/or one or more attributes for each vehicle included in the entity fleet report. In some embodiments, the entity fleet report may only include the vehicles that are associated with a change in status. For example, the entity fleet report may provide an indication of vehicles (e.g., the vehicle identifier) that are no longer associated with the entity and/or an indication of newly purchased vehicles. As such, the entity fleet report may only include information indicative of modifications to the entity's fleet, thereby reducing the amount of computational resources necessary to generate and process the entity fleet report as well as conserving network bandwidth.

In some embodiments, the entity fleet report may provide limited information, such as a total count of vehicles associated with the entity, and may only provide a percentage of vehicles that correspond to a particular vehicle category. For example, the entity fleet report may indicate that an entity is associated with 10,000 vehicles and 98% of those vehicles correspond to a light duty vehicle category and 2% correspond to a heavy duty vehicle category.

In some embodiments, the entity may grant or provide apparatus 200 with limited permissions that allow apparatus 200 to access certain entity information, such as vehicles associated with the entity, from a private network or database associated with the entity. Thus, the entity analysis circuitry 208 may use the communications hardware 206 to access and query the private network or database for one or more vehicles and/or associated information (e.g., unique vehicle identifier, the vehicle type, the vehicle category, one or more vehicles statuses, and/or one or more attributes).

As shown by operation 404, the apparatus 200 includes means, such as processor 202, memory 204, communications hardware 206, entity analysis circuitry 208, and/or the like, for identifying one or more vehicles associated with the entity. The entity analysis circuitry 208 may process the entity fleet report to identify the one or more vehicles described by the entity fleet report. In an instance in which the entity fleet report includes an indication of individual vehicles associated with the entity, the entity analysis circuitry 208 may use this indication of individual vehicles to identify the one or more vehicles associated with the entity. In an instance in which the entity fleet report does not include an indication of individual vehicles, the entity analysis circuitry 208 may determine individual vehicles based on the information provided. By way of continuing example, if the entity fleet report indicates that the entity is associated with 10,000 vehicles and 98% of those vehicles correspond to a light duty vehicle category and 2% correspond to a heavy duty vehicle category, the entity analysis circuitry 208 may determine 9,800 light duty vehicles and 200 heavy duty vehicles for the entity. In some embodiments, each identified vehicle may be associated with a particular vehicle identifier that may be assigned by the entity analysis circuitry 208.

In some embodiments, in an instance in which a current entity fleet metric set is already stored for the entity, the entity analysis circuitry 208 may process the entity fleet report to determine whether the entity fleet report includes any duplicate information (e.g., vehicles already included in the current entity fleet metric set for which information has remained unchanged). In an instance in which duplicate information is determined, the entity analysis circuitry 208 may remove this duplicate information to streamline further processing operations and conserve computational resources.

As shown by operation 406, the apparatus 200 includes means, such as processor 202, memory 204, communications hardware 206, entity analysis circuitry 208, and/or the like, for determining a vehicle category for each identified vehicle. In some embodiments, the entity fleet report may include the vehicle category for each vehicle such that the entity analysis circuitry 208 may use the entity fleet report to determine a vehicle category for each identified vehicle. However, in some embodiments, the entity fleet report may include only limited information regarding each vehicle such that the entity analysis circuitry 208 may perform additional processing to determine a vehicle category and, optionally, a vehicle type and/or one or more attributes for identified vehicles.

In some embodiments, the entity analysis circuitry 208 may provide the entity fleet report to a vehicle identification model. The vehicle identification model may be a machine-learning model or a rules-based model that is configured to process the entity fleet report and determine the vehicle category and, optionally, additional information, such as a vehicle type and/or one or more attributes for identified vehicles. In some embodiments, the vehicle identification model may be a classification model that may use vehicle features extracted from the entity fleet report to determine the vehicle category and additional information. In some embodiments, the vehicle identification model may be configured with a table or list that allows the vehicle identification model to use extracted features (e.g., make, model, manufacturer) to identify a particular vehicle type the vehicle corresponds to. The table or list may be indicative of a vehicle category or may provide vehicle features, such as engine class (e.g., combustion engine, diesel engine, turbojet, gas turbine, electric motor), vehicle weight, etc., that allows the vehicle identification model to determine the vehicle category. In particular, the vehicle identification model may be configured with a set of criteria (e.g., engine requirements, weight requirements) for each vehicle category such that the vehicle identification model may use the extracted vehicle features to determine whether a vehicle satisfies a particular set of criteria associated with a given vehicle category. In an instance where the extracted vehicle features satisfy a particular set of criteria associated with a given vehicle category, the vehicle identification model may determine the vehicle category is associated with the vehicle.

In some embodiments, the vehicle identification model may be configured to use communications hardware 206 to look up vehicle features using industry-standard vehicle identification values, such as a VIN, HUL, identification number, registration number, etc. The communications hardware 206 may return the features of the vehicle, such as the make, model, manufacturer, etc. These extracted features may be used to identify a particular vehicle type within the table or list, as described above.

The vehicle identification model may repeat this process for each identified vehicle. In some embodiments, a vehicle category may be determined for two or more identified vehicles simultaneously, such as by using parallel processing. As such, the computational run time associated with determining a vehicle category for each identified vehicle may be reduced. This may allow for high-performance scaling of the process such that the current entity fleet metric may be feasibly generated within a desired time frame.

As shown by operation 408, the apparatus 200 includes means, such as processor 202, memory 204, communications hardware 206, entity analysis circuitry 208, and/or the like, for determining the current entity fleet metric set based on the one or more identified vehicles. Once the entity analysis circuitry 208 has identified the one or more vehicles from the entity fleet report and determined a vehicle category for each vehicle, the entity analysis circuitry 208 may either generate a new current entity fleet metric set in an instance the entity was previously not associated with a current entity fleet metric set, or it may update an existing entity fleet metric set (e.g., stored in an entity look-up table). The new or updated entity fleet metric set may become the current entity fleet metric set and may be stored in an associated memory, such as memory 204 and/or entity data repository 110. In some embodiments, the current entity fleet metric set may be stored in the entity look-up table and associated with the corresponding entity identifier. The entity analysis circuitry 208 may determine the current entity fleet metric set by accessing the stored current entity fleet metric set from memory and/or the entity look-up table.

Returning now to FIG. 3, as shown by operation 306, the apparatus 200 includes means, such as processor 202, memory 204, communications hardware 206, fleet analysis circuitry 210, and/or the like, for determining a current vehicle estimate metric set. A current vehicle estimate set may include one or more vehicle parameter estimates. A vehicle parameter estimate may be indicative of various estimated values or metrics associated with a particular vehicle and/or vehicle category. For example, vehicle parameter estimates may include an estimated vehicle retirement age, an estimated annual total miles driven by a vehicle, an estimated vehicle cost, an estimated vehicle operation cost per mile, an estimated vehicle geographic investment tax credit (e.g., state-and/or country-specific tax credits), an estimated vehicle initial value, an estimated vehicle annual depreciation rate, an estimated miles per gallon, an estimated emissions legacy (e.g., tons of carbon dioxide per mile), and/or the like.

In some embodiments, a vehicle parameter estimate may be determined based on private data and/or publicly available data. For example, an entity fleet report (e.g., private data managed and provided by the entity) may be processed to determine an estimated annual total miles driven by a vehicle of a particular vehicle category (e.g., light duty vehicles) or a particular vehicle may be estimated to be 13,407 miles. As another example, various vehicle survey data (e.g., publicly available data) may be processed to determine an estimated annual depreciation rate for the particular vehicle category or particular vehicle may be estimated to be 15%.

In some embodiments, a vehicle parameter estimate may correspond to a particular vehicle (e.g., a vehicle corresponding to a particular vehicle identifier). As such, the vehicle parameter estimate may be indicative of exact values captured for the vehicle such that a more granular and accurate analysis may be performed for the vehicle. Alternatively, a vehicle parameter estimate may correspond to a vehicle category. In some embodiments, one or more vehicle parameter estimates may be indicative of an average value determined for a particular vehicle category. While the value determined for the vehicle parameter estimate may not be as accurate for a given vehicle corresponding to the vehicle category, using an average value may allow the process to proceed even in situations in which captured measurements have not been or cannot be obtained for individual vehicles. Furthermore, the use of average values allows the vehicle parameter estimates to maintain accuracy for a given vehicle category. Additionally, in some embodiments, the use of average values for a given vehicle estimate parameter may be preferable, such as in instances when there is little variability in captured values for vehicles of a particular vehicle category, as this does not require individual data processing to determine vehicle-specific vehicle estimate parameters, thus saving computational resources while still maintaining vehicle estimate parameter accuracy.

In some embodiments, the current vehicle estimate metric set may be stored and maintained in an associated memory, such as memory 204 and/or entity data repository 110. In some embodiments, the current vehicle estimate metric set may be associated with the corresponding entity identifier and stored in the entity look-up table. As such, the fleet analysis circuitry 210 may determine the current vehicle estimate metric set by accessing the stored vehicle estimate metric set using the entity look-up table.

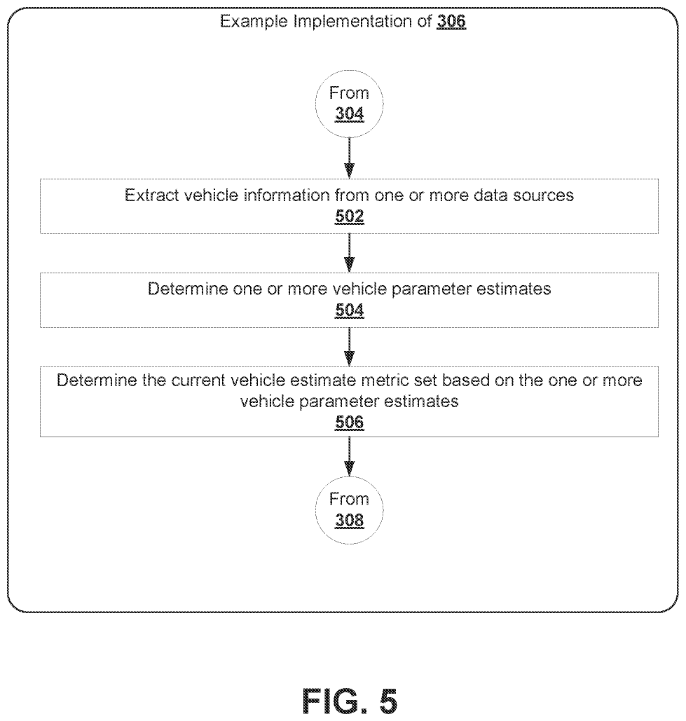

In some embodiments, operation 306 may be performed in accordance with the operations described by FIG. 5. Turning to FIG. 5, example operations are shown for determining the current vehicle estimate metric set based on one or more vehicle parameter estimates.

As shown by operation 502, the apparatus 200 includes means, such as processor 202, memory 204, communications hardware 206, fleet analysis circuitry 210 and/or the like, for extracting vehicle information from one or more data sources. The fleet analysis circuitry 210 may search trusted data sources for vehicle information to extract, which can then be used to determine the one or more vehicle estimates. The one or more data sources used by the fleet analysis circuitry 210 may correspond to verified or trusted online sources. For example, data sources may include the official website of the entity, publicly available reports from the entity, and/or publicly available reports or surveys from a regulatory entity (e.g., the Department of Transportation, the Environmental Protection Agency, the Department of Energy, vehicle surveys).

In some embodiments, a data source corresponds to the entity fleet report, as described above with respect to FIG. 5. The entity fleet report may be indicative of the one or more vehicles currently associated with the entity and, in some embodiments, may further include one or more attributes for each vehicle included in the entity fleet report. In some embodiments, one or more attributes are indicative of vehicle information that may be subsequently used to determine the one or more vehicle parameter estimates. For example, the one or more attributes may be indicative of a color, make, model, manufacturing year, vehicle age, purchase date, purchase price, mileage, accident report, fuel usage, type of fuel used, annual depreciation rate, annual miles driven, miles driven to date, average miles per gallon measures, emissions measures, etc.

The fleet analysis circuitry 210 may search the one or more data sources for vehicle information. Vehicle information may pertain to any information related to captured vehicle metrics for a particular vehicle or vehicle category. In some embodiments, the fleet analysis circuitry 210 may be configured to use a web crawler and/or one or more identification models to identify vehicle information. The one or more identification models may use various image-processing tools, such as optical character recognition (OCR) and/or language processing techniques to identify and extract vehicle information from the one or more data sources.

As shown by operation 504, the apparatus 200 includes means, such as processor 202, memory 204, communications hardware 206, fleet analysis circuitry 210, and/or the like, for determining one or more vehicle parameter estimates. The fleet analysis circuitry 210 may process the extracted vehicle information to determine the one or more vehicle parameter estimates. In some embodiments, the fleet analysis circuitry 210 may use one or more processing models to process the extracted vehicle information and determine the one or more vehicle parameter estimates. In some embodiments, the one or more processing models may be machine-learning and/or rules-based models configured to determine the one or more vehicle parameter estimates. In some embodiments, a processing model may use a term frequency-inverse document frequency algorithm and/or be a word2vec model, a bidirectional encoder representation from transformers (BERT) model, or a large language model (LLM). The one or more processing models may be configured to identify relationships between words such that the one or more vehicle parameter estimates may be determined. For example, the one or more processing models may be configured to identify terms indicative of a particular vehicle parameter estimate and determine the corresponding value for the vehicle parameter estimate. Furthermore, the one or more processing models may determine a vehicle identifier and/or vehicle category to which a vehicle parameter estimate corresponds.

In some embodiments, the one or more processing models may be further configured to perform one or more mathematical and/or logical operations on values for a vehicle parameter estimate to determine a value for another vehicle parameter estimate. For example, the one or more processing models may be configured to determine all values of a vehicle parameter estimate for individual light duty vehicles and average these values to determine a value for a vehicle parameter estimate for a light duty vehicle category.

The one or more processing models may determine the two or more vehicle parameter estimates simultaneously, such as by using parallel processing. As such, the computational run time associated with determining the one or more vehicle parameter estimates for a current vehicle estimate metric set may be reduced. This may allow for high-performance scaling of the process such that the current entity fleet metric may be feasibly generated within a desired time frame.

As shown by operation 506, the apparatus 200 includes means, such as processor 202, memory 204, communications hardware 206, fleet analysis circuitry 210, and/or the like, for determining the current vehicle estimate metric set based on the one or more vehicle parameter estimates. Once the fleet analysis circuitry 210 has determined the one or more vehicle parameter estimates, the fleet analysis circuitry 210 may either generate a new current vehicle estimate metric set in an instance the entity was previously not associated with a current vehicle estimate metric set, or may update an existing vehicle estimate metric set (e.g., stored in an entity look-up table). The new or updated vehicle estimate metric set may become the current vehicle estimate metric set and may be stored in an associated memory, such as memory 204 and/or entity data repository 110. In some embodiments, the current vehicle estimate metric set may be stored in the entity look-up table and associated with the corresponding entity identifier. The entity analysis circuitry 208 may determine the current vehicle estimate metric set by accessing the stored current entity fleet metric set from memory and/or the entity look-up table.

Returning now to FIG. 3, optionally, as shown by operation 308, the apparatus 200 includes means, such as processor 202, memory 204, communications hardware 206, prediction circuitry 216, and/or the like, for determining one or more predicted inventory events. In some embodiments, a predicted inventory event may be either a forecast or prediction of an inventory event that has yet to occur. A predicted inventory event may be associated with a particular vehicle category and an event time frame. The event time frame may be indicative of a predicted time frame that the predicted inventory event is predicted to occur within, as well as the duration of the predicted event. For example, the predicted event time frame may be the summer months of the year 2025 such that the event is predicted to begin in June of 2025 and persist through August of 2025. A predicted inventory event may be indicative of a predicted availability of product for a particular vehicle or vehicle category. For example, a predicted inventory event may correspond to an inventory shortage for particular vehicle types and/or vehicle categories (e.g., electric vehicles). As such, a predicted inventory event may describe a predicted availability of a particular vehicle or vehicle category during the associated predicted event time frame. For example, a predicted inventory event may be indicative of a predicted shortage of electric light duty vehicles during the months of June through August of 2025. As another example, a predicted inventory event may correspond to an inventory surplus for particular vehicle types and/or vehicle categories (e.g., electric vehicles). This may be indicative of a time frame during which vehicle prices are relatively low due to the volume of available vehicles.

In some embodiments, the one or more predicted inventory events may be determined based on predictions determined and/or obtained from one or more trusted data sources. Thus, in some embodiments, the prediction circuitry 216 may determine a predicted inventory event directly from currently available information. For example, one or more vehicle shortage forecasts may be publicly available from one or more trusted data sources. In some embodiments, the prediction circuitry 216 may be configured to use a web crawler and/or one or more identification models to identify inventory event information. The one or more identification models may use various image-processing tools, such as OCR and/or language processing techniques to identify and extract inventory event information from the one or more data sources. In some embodiments, the prediction circuitry 216 may use one or more prediction models to process the extracted inventory event information and determine the one or more predicted inventory events. Thus, in some embodiments, the prediction circuitry 216 may determine a predicted inventory event by generating predicted data based on currently available information and using the one or more predictions models. In some embodiments, the one or more prediction models may be machine-learning and/or rules-based models configured to determine the one or more predicted inventory events. In some embodiments, a prediction model may use a term frequency-inverse document frequency algorithm and/or be a word2vec model, a BERT model, or a LLM. The one or more prediction models may be configured to identify relationships between words such that the one or more predicted inventory events may be determined. For example, the one or more prediction models may be configured to identify terms indicative of a particular vehicle type or vehicle category and an availability of the vehicle or vehicle category. Furthermore, the one or more prediction models may determine an associated time frame for the event to occur.

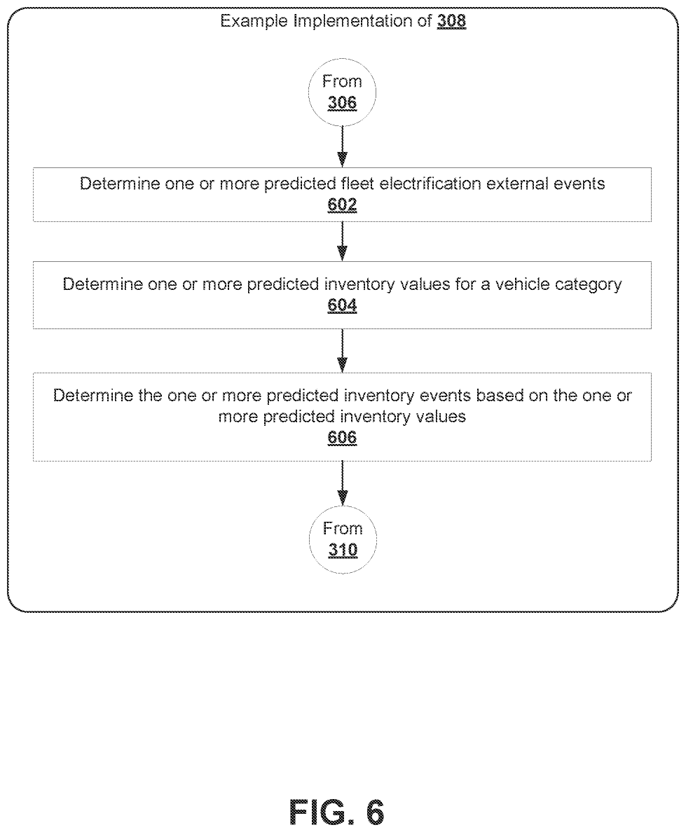

In some embodiments, the prediction circuitry 216 may use one or more stored and/or managed fleet transitioned climate impact reports pertaining to one or more external entities to determine the one or more predicted inventory events, as described in further detail in FIG. 6.

In some embodiments, operation 308 may be performed in accordance with the operations described by FIG. 6. Turning now to FIG. 6, example operations are shown for determining one or more predicted inventory events based on one or more predicted inventory values.

As shown by operation 602, the apparatus 200 includes means, such as processor 202, memory 204, communications hardware 206, prediction circuitry 216, and/or the like, for determining one or more predicted fleet electrification external events. A predicted fleet electrification external event may correspond to an external entity and be associated with a predicted event time frame. In particular, a predicted fleet electrification external event may be indicative of a predicted modification to the fleet of an external entity (e.g., an entity other than the entity of interest for which the fleet transition climate impact report is being generated). For example, a predicted fleet electrification external event may describe a particular external entity purchasing a particular vehicle type or category of vehicle (e.g., any electric vehicle category).

In some embodiments, the one or more external entities may have previously requested a fleet transition climate impact report such that the external entities are associated with fleet transition climate impact reports that include a recommended fleet electrification schedule. The prediction circuitry 216 may access recommended fleet electrification schedules for the one or more external entities, which may be stored and/or maintained in an associated memory, such as memory 204, entity data repository 110, and/or the entity look-up table. In some embodiments, the one or more external entities may be required to opt in to an information-sharing program before the recommended fleet electrification schedules may be accessed for the external entities. As described in greater detail below, a recommended fleet electrification schedule may include one or more recommended fleet electrification events, a recommended event time frame, and one or more target fleet electrification goals. The prediction circuitry 216 may use this information to determine one or more predicted fleet electrification events for a given external entity. This may be repeated for any number of external entities associated with a recommended fleet electrification schedule.

As shown by operation 604, the apparatus 200 includes means, such as processor 202, memory 204, communications hardware 206, prediction circuitry 216, and/or the like, for determining one or more predicted inventory values for a vehicle category. A predicted inventory value may be indicative of a predicted availability of vehicles for a particular vehicle category and/or vehicle type. In some embodiments, the predicted inventory value may be categorical. For example, a predicted inventory value may correspond to a surplus, available, limited availability, no availability, and/or the like.

In some embodiments, the prediction circuitry 216 may use one or more forecasting models to determine the one or more predicted inventory values for a vehicle category. The one or more forecasting models may be machine-learning models and/or rules-based models that are configured to process the one or more predicted fleet electrification events and determine the one or more predicted inventory values for a vehicle category. In some embodiments, a forecasting model may be a convolutional neural network (CNN) or a recurrent neural network (RNN). A forecasting model may use the information provided by the predicted fleet electrification events to identify overlapping predicted fleet electrification events that are similar (e.g., are associated with a same vehicle type or vehicle category), which may indicate a time frame of heightened demand for a particular vehicle type or vehicle category. This may indicate a time frame where vehicle demand is greater than a vehicle supply. The forecasting model may be trained using historical vehicle sales and/or availability to find particular time frames to identify patterns in vehicle availability. The forecasting model may then determine one or more predicted fleet electrification external events for one or more vehicle types and/or vehicle categories.

As shown by operation 606, the apparatus 200 includes means, such as processor 202, memory 204, communications hardware 206, prediction circuitry 216, and/or the like, for determining the one or more predicted inventory events based on the one or more predicted inventory values. The prediction circuitry 216 may use the one or more predicted inventory values to then determine the one or more predicted inventory events. In some embodiments, each category of a predicted inventory value may correspond to a predicted inventory event. For example, a predicted inventory value of a surplus may correspond to a surplus predicted inventory event. As another example, a predicted inventory value of available may correspond to an available predicted inventory event. As yet another example, a predicted inventory value of limited availability or low availability may correspond to a shortage predicted inventory event.

Returning now to FIG. 3, as shown by operation 310, the apparatus 200 includes means, such as processor 202, memory 204, communications hardware 206, fleet electrification circuitry 212, and/or the like, for generating a recommended fleet electrification schedule. In some embodiments, the fleet electrification circuitry 212 may generate the recommended fleet electrification schedule based on the current entity fleet metric set, the current vehicle estimate metric set, and the one or more emission target goals included in the fleet transition climate impact report. A recommended fleet electrification schedule may include one or more recommended fleet electrification events, which may each by associated with a recommended event time frame. Additionally, each recommended fleet electrification event may be associated with one or more target fleet electrification goals. In some embodiments, a target fleet electrification goal corresponds to a particular percentage or amount of an entity's fleet corresponding to an electric vehicle category. The target fleet electrification events included in the recommended fleet schedule may be ordered in chronological order based on the recommended event time frame associated with a given target fleet electrification event. For example, a target fleet electrification event associated with a recommended event time frame that occurs between the beginning of the year 2024 and the end of year 2024 may precede a target fleet electrification event associated with a recommended event time frame of the beginning of the year 2024 and the end of the year 2025.

A recommended fleet electrification event may be indicative of a target for the entity in order to reach the one or more emission target goals included in the fleet transition climate impact report request. For example, an emission target goal may be for the entity to become carbon neutral by 2035 (e.g., the associated goal completion date). As such, the recommended fleet electrification events may describe target fleet electrification goals an entity should achieve to transition an existing entity vehicle fleet to include only vehicles corresponding to an electric vehicle category. For example, a first recommended fleet electrification event may correspond to transitioning 3% of the entity's vehicle fleet to electric vehicles by the end of the year 2024. Here, the target fleet electrification goal is for 3% of the entity's vehicles to correspond to an electric vehicle category, and a recommended event time frame may be between now and the end of the year 2024. As another example, a recommended fleet electrification event may correspond to transitioning 6% of the entity's vehicles fleet to electric vehicles by the end of the year 2025. Here, the target fleet electrification goal is for 6% of the entity's vehicles to correspond to an electric vehicle category, and a recommended event time frame may be between the beginning of the year 2025 and the end of the year 2025.

In some embodiments, the fleet electrification circuitry 212 may determine exact counts for target fleet electrification goals. For example, the entity fleet report may indicate that an entity is associated with 10,000 vehicles with 0% of those vehicles corresponding to an electric vehicle category. As such, the fleet electrification circuitry 212 may determine a count of 300 vehicles needed to achieve the target fleet electrification goal of 3% of the entity's vehicles fleet to correspond to an electric vehicle category. In some embodiments, the fleet electrification circuitry 212 may further determine counts for different vehicle categories. For example, the entity fleet report may indicate that an entity is associated with 10,000 vehicles and 98% of those vehicles correspond to a light duty vehicle category and 2% correspond to a heavy duty vehicle category. As such, the fleet electrification circuitry 212 may determine 9,800 vehicles correspond to a light duty vehicle classification and 200 vehicles correspond to a heavy duty vehicle category and subsequently determine the counts for each vehicle classification proportionally. In particular, the fleet electrification circuitry 212 may determine a count of 294 vehicles needed for an electric light duty vehicle classification and six vehicles needed for an electric heavy duty vehicle classification to achieve the target fleet electrification goal of 3% of the entity's vehicles fleet to correspond to an electric vehicle category.

In some embodiments, the fleet electrification circuitry 212 may use a scheduling optimization model to generate the recommended fleet electrification schedule. The scheduling optimization model may be a machine-learning model, such as a neural network, and/or a rules-based model configured to process the current entity fleet metric set, the current vehicle estimate metric set, and the one or more emission target goals included in the fleet transition climate impact report to generate the recommended fleet electrification schedule. In some embodiments, the scheduling optimization model may additionally process a preferred pace if included in the fleet transition climate impact report request. The scheduling optimization may utilize one or more optimization algorithms, such as a gradient descent and/or cross-entropy, to determine an optimal number of recommended fleet electrification events, as well as a pacing of target fleet electrification goals for vehicles and/or vehicle categories. For example, the scheduling optimization model may use the current entity fleet metric set to identify time periods during which a number of vehicles will likely be retired and thus recommend replacing these vehicles with vehicles corresponding to an electric vehicle category. The scheduling optimization model may use the current vehicle estimate set to determine various parameters, such as an average age of vehicle associated with the entity. Additionally, in some embodiments, the scheduling optimization model may further determine one or more specific vehicles to retire and replace with a similar vehicle corresponding to an electric vehicle type. For example, a vehicle corresponding to a light duty vehicle category may be five years old, which may be the average age of retirement for vehicles associated with the entity. As such, the scheduling optimization model may determine to replace the particular vehicle with a vehicle corresponding to an electric light duty vehicle category. As another example, the scheduling optimization model may determine whether it may be more cost effective (e.g., due to operations savings, tax credit values, emission savings) to replace a portion of the vehicle fleet with vehicles corresponding to an electric vehicle category.

Additionally, in some embodiments, the scheduling optimization model may determine a recommended vehicle status for one or more vehicles associated with a target fleet electrification goal. For example, the scheduling optimization model may determine whether it may be more beneficial for the entity to buy or lease a vehicle required for the target fleet electrification goal and may indicate this determination in a recommended vehicle status. For example, a target fleet electrification goal indicative of 3% of the vehicles in the entity fleet to correspond to an electric vehicle category. The scheduling optimization model may further determine that 0.5% of the vehicles should be leased such that a target fleet electrification goal may indicate that 0.5% of the vehicles in the entity fleet should correspond to an electric vehicle category and be associated with a leased vehicle status while the other 2.5% of the vehicles in the entity fleet should correspond to an electric vehicle category and be associated with an owned vehicle status.

In some embodiments, the scheduling optimization model may further determine an optimal location to purchase one or more vehicles. The scheduling optimization model may determine the one or more optimal locations based on the current vehicle estimate metric set and/or other information. The current vehicle estimate metric set may include vehicle parameter estimates such as state-and/or country-specific investment tax credit information. As such, the scheduling optimization model may include the location determined to result in the optimal benefits for the entity in the recommended fleet electrification events.

In some embodiments, the scheduling optimization model may additionally consider one or more regulatory standard pacing guidelines when determining a pacing of target fleet electrification goals for vehicles and/or vehicle categories. In some embodiments, the scheduling optimization model may be configured to access a regulatory standard pacing guideline repository that includes one or more regulatory standard pacing guidelines developed by one or more regulators or standards setting entities. The regulatory standard pacing guideline repository may also include the locations each regulatory or standard setting entity operates within as well as a magnitude of influence for each regulatory or standard setting entity. These regulatory standard pacing guidelines may provide an indication of a preferred paths and/or pacing of fleet electrification for a particular regulatory or standards entity and the scheduling optimization model may consider one or more of these regulatory standards pacing guidelines when determining target fleet electrification goals. For example, regulatory standard pacing guidelines for regulatory body A may indicate it is preferable to have a non-linear electrification curve or pace and have initially higher pacing of target fleet electrification goals early on. Alternatively, regulatory standard pacing guidelines for regulatory body B may indicate it is preferable to have a non-linear electrification curve or pace and have initially lower pacing of target fleet electrification goals and then higher pacing of target fleet electrification goals later on. The scheduling optimization model may determine that the requesting entity operates in locations where regulatory body B has a larger influence and therefore, may determine target fleet electrification goals for the entity in-line with regulatory standard pacing guidelines provided by regulatory body B.

In some embodiments, the scheduling optimization model may additionally process the one or more predicted inventory events such that the generated recommended fleet electrification schedule is further based on the one or more predicted inventory events. The scheduling optimization model may be configured to determine order and recommended event time frame for the one or more recommended fleet electrification events based on the predicted inventory events. For example, the scheduling optimization model may generate recommended fleet electrification events with recommended event time frames that exclude periods found to be associated predicted inventory events indicative of predicted shortages of vehicles corresponding to electric vehicles categories. As another example, the scheduling optimization model may generate recommended fleet electrification events with recommended event time frames that encourage increased buying (e.g., higher target fleet electrification goals) during periods found to be associated predicted inventory events indicative of predicted surplus of vehicles corresponding to electric vehicles categories.

In some embodiments, the scheduling optimization model may determine an inferred social benefit and use the inferred social benefit when generating the recommended fleet electrification schedule. For example, the scheduling optimization model may use various analytical analyses, such as multi-criteria decision analysis, health impact assessment, environmental impact assessment, social return on investment, and/or the like to evaluate an overall social benefit of a particular target fleet electrification goals. For example, the scheduling optimization model may determine a greater social benefit for a target fleet electrification goal that describes transitioning vehicles that operate within or nearby fence line communities, as this would lessen air pollution. As another example, the scheduling optimization model may determine a greater social benefit in transitioning heavy duty vehicles operating within a community with restricted operation times due to noise restrictions. Transitioning these heavy duty vehicles may allow for a license extension to allow the transitioned vehicle to operate later in the night and further, may allow for quieter, safer, and cleaner vehicle operations.

In some embodiments, the scheduling optimization model may perform simultaneous calculations or determinations using a variety of different considerations and/or criteria to determine candidate recommended fleet electrification schedules, such as by using parallel processing. The scheduling optimization model may evaluate each candidate recommended fleet electrification schedule to determine an optimal candidate recommended fleet electrification schedule that reaches the one or more emission target goals included in the fleet transition climate impact report in a cost-efficient, resource-efficient, compliant, and socially beneficial manner. The optimal candidate recommended fleet electrification schedule is then selected as the recommended fleet electrification schedule by the scheduling optimization model.

Optionally as shown by operation 312, the apparatus 200 includes means, such as processor 202, memory 204, communications hardware 206, fleet electrification circuitry 212, and/or the like, for determining one or more recommended products. In some embodiments, the fleet electrification circuitry 212 may determine one or more recommended products for the entity. The one or more recommended products may be vehicles that are determined to aid the entity with achieving the one or more target electrification goals associated with a recommended fleet electrification event. The fleet electrification circuitry 212 may determine one or more vehicles that satisfy criteria associated with a target fleet electrification goal. For example, a target fleet electrification goal may indicate 3% of the entity's vehicle fleet should correspond to an electric light duty vehicle category, with 0.5% of those vehicles associated with a leased vehicle status and 2.5% associated with an owned vehicle status. Additionally, a target fleet electrification goal may be indicative of an optimal location of California to purchase and/or lease vehicles. These factors may all be considered criteria necessary to satisfy the target fleet electrification goal. As such, the fleet electrification circuitry 212 may process this criteria and identify one or more vehicles that fit this criteria.

In some embodiments, the fleet electrification circuitry 212 may use the communications hardware 206 to perform searches or queries on one or more vehicle merchant sites and identify one or more currently available products. The fleet electrification circuitry 212 may review each identified product to determine whether the product and product attributes satisfy the criteria associated with the one or more target fleet electrification goals. In an instance the fleet electrification circuitry 212 determines the product and product attributes satisfy the criteria associated with the one or more target fleet electrification goals, the fleet electrification circuitry 212 may determine the product is a recommended product. The one or more recommended products may be included in the fleet transition climate impact report along with a hyperlink or link to the product, such that an end user may use the included hyperlink or link to access each recommended product.

Optionally, as shown by operation 314, the apparatus 200 includes means, such as processor 202, memory 204, communications hardware 206, fleet electrification circuitry 212, and/or the like, for determining one or more projection metrics for one or more recommended electrification fleet events. In some embodiments, the fleet electrification circuitry 212 may further determine one or more projection metrics for the one or more recommended electrification fleet events. A projection metric may correspond to a metric category and may be indicative of a predicted value for the metric category assuming the entity achieves the one or more target fleet electrification goals associated with the recommended fleet electrification event. A metric category may correspond to an entity metric that is influenced by replacing vehicles corresponding to a non-electric vehicle category with vehicles of an electric vehicle category. For example, a metric category may include annual/cumulative corporate fleet emissions, annual/cumulative fossil fuel fleet size, annual/cumulative electrified fleet size, annual/cumulative fleet operational cost, annual/cumulative count of vehicles retired, annual/cumulative count of vehicles purchased, annual/cumulative cost of vehicle acquisition, annual/cumulative gallons of fuel used, annual/cumulative gallons of fuel saved, annual/cumulative emission savings, annual/cumulative operational cost savings, annual/cumulative fleet insurance costs, total cost over lifetime of ownership, an equivalency of trees planted and grown in a number of years, and/or the like.

The fleet electrification circuitry 212 may determine a value for each projection metric of a given metric category by comparing a value for the current entity vehicle fleet as compared to an entity vehicle fleet that achieves the target fleet electrification goals laid out by a particular recommended fleet electrification event. In particular, the fleet electrification circuitry 212 may determine a predicted entity fleet metric set that includes predicted vehicles as well as a portion of vehicles included in the current entity fleet metric set. The predicted entity fleet metric set may be determined based on the target fleet electrification goals. For example, the current entity fleet metric set may include 10,000 vehicles, with 9,800 light duty vehicles and 200 heavy duty vehicles for the entity. A target fleet electrification goal of 3% of the vehicles in the entity fleet should correspond to an electric vehicle category. Thus, the predicted entity fleet metric set may include 294 vehicles corresponding to an electric light duty vehicle classification, six vehicles corresponding to an electric heavy duty vehicle classification, 9,506 vehicles corresponding to a light duty vehicle classification, and 194 vehicles corresponding to a heavy duty vehicle classification. The fleet electrification circuitry 212 may use the predicted entity fleet metric set to determine the one or more projection metrics. In some embodiments, the fleet electrification circuitry 212 may additionally use the current vehicle estimate metric set, which may provide additional vehicle estimate parameters for the predicted vehicles.

For example, the fleet electrification circuitry 212 may determine a predicted total cost of fuel (e.g., a metric category) for the predicted entity fleet metric set. In some embodiments, the fleet electrification circuitry 212 may further determine a current total cost of fuel for the current entity fleet metric set. In some embodiments, the fleet electrification circuitry 212 may perform additional mathematical and/or logical operations on the results of using the predicted entity fleet metric set and the current entity fleet metric set. For example, the fleet electrification circuitry 212 may determine a total estimated cost savings of fuel by determining the difference between the predicted total cost of fuel and the current total cost of fuel. The difference between the totals may be the projection metric for the annual gallons of fuel saved.

In some embodiments, the fleet electrification circuitry 212 may determine infrastructure metrics associated with transitioning an entity fleet for each target fleet electrification goal of a recommended fleet electrification event. Infrastructure metrics may include an estimated cost of installing charging infrastructure, purchase of portable chargers, and/or purchase of other accessories. In some embodiments, the fleet electrification circuitry 212 may determine infrastructure metrics based on publically available information, such as item and/or installation costs published online. In some embodiments, the fleet electrification circuitry 212 may determine infrastructure metrics based on historical infrastructure metrics associated with the entity and/or external entities accessible to the fleet electrification circuitry 212. In some embodiments, the fleet electrification circuitry 212 may consider infrastructure metrics based on the location of the vehicle to be transitioned. For example, infrastructure metrics may vary between locations due to labor and/or material availability. In some embodiments, the fleet electrification circuitry 212 may determine the infrastructure metrics assuming a 1 to 1 ratio between vehicles corresponding to an electric vehicle category and particular infrastructure (e.g., charging station, portable charger, other accessories, and/or the like). However, other infrastructure metric ratios may be configured by an end user or indicated in the fleet transition climate impact report.

Optionally, as shown by operation 316, the apparatus 200 includes means, such as processor 202, memory 204, communications hardware 206, fleet electrification circuitry 212, and/or the like, for generating one or more insights. In some embodiments, the fleet electrification circuitry 212 may determine the one or more insights based on the one or more recommended fleet electrification events. Each insight may provide an explanation of one or more recommended fleet electrification events and/or an inferred cause for a target fleet electrification goal, recommended event time frame, and/or projection metrics associated with a given recommended fleet electrification event. Thus, the one or more insights may aid the user with determining how and/or why a particular recommended fleet electrification event was determined.

In some embodiments, the fleet electrification circuitry 212 may use an insight inference framework to generate the one or more insights. The insight inference framework may include one or more inference models and one or more insight generation models. The one or more inference models may be machine-learning models or rules-based models configured to process the recommended fleet electrification schedule, the current entity fleet metric set, and/or the current vehicle estimate metric set and output one or more contributing factors determined to have had a significant impact on the determination of a given target fleet electrification goal, recommended event time frame, and/or projection metrics associated with a given recommended fleet electrification event. In some embodiments, the one or more inference models may additionally process the fleet transition climate impact request and/or the one or more predicted inventory events. In some embodiments, an inference model may be a neural network, deep neural network, LLM, regression model, or decision tree. As such, the one or more inference models may provide interpretability for the operational process used to determine the particular recommended fleet electrification event. In some embodiments, the one or more inference models may be configured to provide the one or more contributing factors to one or more insight generation models. Additionally, the one or more inference models may be trained to determine the cause-and-effect relationship between projection metrics and a change within an entity's vehicle fleet (e.g., as indicated by a predicted entity fleet metric set).

In some embodiments, each inference model may be trained using historical recommended fleet electrification event data. In some embodiments, the historical recommended fleet electrification event data may be labeled or annotated with known contributing factors such that the inference model may be trained to detect and determine patterns and/or connections between known contributing factors and a recommended fleet electrification event.

The one or more insight generation models may be machine-learning models or rules-based models configured to receive the one or more contributing factors determined by the one or more inference models and generate the one or more insights for the entity asset. In some embodiments, an insight generation model may be a LLM or other language model that is configured to generate text that provides an indication of the contributing factors that influenced the one or more recommended fleet electrification events. In particular, the insight generation model may be configured to provide an explanation of why a particular recommended event time frame and/or one or more target fleet electrification goals were determined. Additionally, the one or more insights may provide an explanation of the one or more projection metrics. For example, an insight may describe that the projection metric for the annual gallons of fuel saved increased due to replacing vehicles corresponding to a non-electric vehicle category with vehicles corresponding to an electric vehicle category.

In some embodiments, the one or more insight generation models may determine a breakeven point in the recommended fleet electrification schedule. A breakeven point may be indicative of a recommended fleet electrification event or time frame within which the predicted cost of transitioning the entity fleet to an electric vehicle category is equal to the cost savings provided by the electric vehicles in the entity fleet. The breakeven point may be indicative of an inflection period when the entity fleet transition begins to realize the benefits provided by transitioning the entity fleet to electric vehicles in view of the up-front transition cost. The breakeven point may aid end-users with understanding the long-term strategy of fleet electrification as well as financial resource allocation. The breakeven point may also provide an indication of a “loss” time period (e.g. time period prior to the breakeven point) and “profit” period (e.g. time period after the breakeven point).

The one or more insight generation models may calculate the breakeven point based on the one or more projection metrics. In some embodiments, the one or more insight generation models may determine the cumulative fleet operating costs associated with a cumulative fleet operating cost metric category and a cumulative operational cost savings associated with an operational cost savings metric category for one or more recommended fleet electrification event. The one or more insight generation models may compare the cumulative fleet operating cost and cumulative operation cost savings for recommended fleet electrification events in chronological order until the cumulative operation cost savings is found to equal or surpass the cumulative fleet operating cost. Thus, the one or more insight generation models may determine the particular recommended fleet electrification event that causes the breakeven point. Additionally or alternatively, the one or more insight generation models may determine the date associated with a vehicle transition or identifier or count of a particular vehicle transition to an electric vehicle that causes the breakeven point. For example, the one or more insight generation models may determine a cumulative operation cost savings projection metric and cumulative fleet operating cost for each vehicle transition within an entity fleet. Thus, the particular vehicle transition which causes the breakeven point may be determined.

In some embodiments, the one or more insight generation models may determine one or more comparative predicted fleet electrification schedules for peer entities, which may be external entities. The one or more comparative predicted fleet electrification schedules may provide a reference of the pace of fleet electrification for peer entities. A peer entity may be a type of external entity that shares one or more elements with the requesting entity. For example, a peer entity may operate within one or more of the same industries or categories as the requesting entity, has comparable fleet size and/or composition, has comparable emission target goals, etc. In some embodiments, a peer entity may have previously requested a fleet transition climate impact report such that the predicted fleet electrification schedule for the peer entity included in the fleet transition climate impact report may be determined for the peer entity. In some embodiments, the one or more insight generation models may identify a peer entity for the requesting entity that is not associated with a stored fleet transition climate impact report. For example, the fleet transition climate impact report request provided in 302 may include one or more indications of peer entities of interest (e.g., peer entity name) or the one or more insight generation model may process publicly available data to determine comparisons between a peer entity and the requesting entity have been made, such as by using suitable NLP techniques. The one or more insight generation models may then determine search various online sources for publicly available data pertaining to a peer entity and use this data determine a predicted fleet electrification schedule for a given peer entity.

The one or more insight models may determine the predicted fleet electrification schedule for a peer entity in a similar manner as described in operations 310 and by leveraging fleet electrification circuitry 212. Each predicted fleet electrification schedule for a peer entity may include predicted fleet electrification events and a predicted event time frame. The one or more insight models may identify corresponding predicted fleet electrification events for a given peer entity and recommended fleet electrification events for the requesting entity based on the associated event time frames. The one or more insight models may then perform a comparative analysis a given peer entity and the requesting entity based on the corresponding fleet electrification events and event time frames for both entities. For example, the one or more insight models may determine the requesting entity has a similar entity fleet electrification pacing percentage (e.g., 10% of the entity's vehicle fleet transitioned to electric vehicles per year) as peer entity A but the count of vehicles transitioned is larger than peer entity A due to the requesting entity's comparatively larger entity fleet size. As another example, the one or more insight models may determine the requesting entity and peer entity B have similar overall fleet electrification goals of 100% fleet electrification within 10 years but the requesting entity has a slower and linear entity fleet electrification pacing percentage (e.g., 10% of the entity's vehicle fleet transitioned to electric vehicles per year) as compared to peer entity B (e.g., 15% of the entity's vehicle fleet transitioned to electric vehicles in the first 5 years but then slows 5% in the next 5 years). These peer entity insights may aid end users of the requesting entity with planning fleet electrification goals.

As shown by operation 318, the apparatus 200 includes means, such as processor 202, memory 204, communications hardware 206, fleet electrification circuitry 212, and/or the like, for generating a fleet transition climate impact report. Once the fleet electrification circuitry 212 has generated the recommended fleet electrification schedule, the fleet electrification circuitry 212 may generate the fleet transition climate impact report. The fleet transition climate impact report may include the one recommended fleet electrification schedule generated in operation 310. In some embodiments, the fleet transition climate impact report may additionally include the one or more projection metrics determined for one or more recommended electrification fleet events, one or more insights, one or more recommended products, an indication of one or more predicted inventory events, one or more entity fleet metrics included in the current entity fleet metric set, one or more current vehicle estimate sets, and/or one or more implementation service offers.

The fleet electrification circuitry 212 may generate the fleet transition climate impact report in any suitable format. For example, the fleet transition climate impact report may be formatted as an electronic document. An electronic document may include file formats, such as an email, a portable document file, an image file, a comma separated value file, an extensible markup language file, a text file, a spreadsheet file, and/or the like. In some embodiments, the fleet transition climate impact report may be a website page or code that is accessible to an authorized end-user. In some embodiments, an authorized end-user may be a user with credentials that are associated with the entity identifier of the corresponding entity. In some embodiments, the entity look-up table may further include authorized user credentials for users authorized to view the fleet transition climate impact report for the corresponding entity. In some embodiments, the fleet transition climate impact report may be formatted as a physical file. For example, the fleet electrification circuitry 212 may transform an electronic file to a physical file such as by printing the electronic file to generate the fleet transition climate impact report.

As shown by operation 320, the apparatus 200 includes means, such as processor 202, memory 204, communications hardware 206, fleet electrification circuitry 212, and/or the like, for providing the fleet transition climate impact report. Once the fleet electrification circuitry 212 has generated the fleet transition climate impact report, the fleet transition climate impact report may be provided to one or more users via one or more devices (e.g., entity device 106A-106N or third-party device 108A-108N). The fleet transition climate impact report may be provided to the device that provided the fleet transition climate impact report request, as well as additional devices indicated by the fleet transition climate impact report request. In some embodiments, the fleet transition climate impact report may also be stored in an associated memory, such as memory 204 and/or entity data repository 110. In some embodiments, the fleet transition climate impact report may be stored in the entity look-up table and associated with the appropriate entity identifier.

The manner in which the fleet transition climate impact report is provided may be dependent upon the format of the fleet transition climate impact report. For example, fleet transition climate impact reports formatted as a portable document file, an image file, a comma separated value file, an extensible markup language file, a text file, a spreadsheet file, and/or the like may be provided in any suitable manner, such as by using a file transfer service, via email, upload onto removable hardware, etc. Links to the file transfer service and/or email may be provided to the one or more devices (e.g., entity device 106A-106N or third-party device 108A-108N). In an instance in which the fleet transition climate impact report is formatted as a website page or code that is accessible to an authorized end-user, a link to website may be provided to the one or more devices (e.g., entity device 106A-106N or third-party device 108A-108N). In an instance in which the fleet transition climate impact report is formatted as a website code that is accessible to an authorized end-user, the content may be provided to a data repository (e.g., entity data repository 110) and may be used by the fleet electrification circuitry 212. In an instance in which the fleet transition climate impact report is a physical file, the fleet transition climate impact report may be sent and/or delivered to one or more addresses associated with the entity.

In some embodiments, the fleet transition climate impact report may further include a link to a fleet performance dashboard for the entity. The fleet performance dashboard may be a visual tool or interface maintained by fleet electrification circuitry 212 and may be associated with the entity identifier such that is accessible to the entity using valid entity credentials. The fleet performance dashboard may provide a live indication of current entity fleet performance as well as historical entity fleet performance across various metric categories. As such, the fleet performance dashboard may provide an entity with a current indication of their overall fleet performance. For example, the fleet performance dashboard may describe current vehicle parameters estimates for each vehicle in the entity fleet, a vehicle category, and/or the entire entity fleet. Vehicle parameters estimates may include an estimated vehicle retirement age, an estimated annual total miles driven by a vehicle, an estimated vehicle cost, an estimated vehicle operation cost per mile, an estimated vehicle geographic investment tax credit (e.g., state-and/or country-specific tax credits), an estimated vehicle initial value, an estimated vehicle annual depreciation rate, an estimated miles per gallon, an estimated emissions legacy (e.g., tons of carbon dioxide per mile), and/or the like. In some embodiments, as described in operation 306 of FIG. 3, vehicle parameter estimates may be indicative of exact values captured for the vehicle.

In some embodiments, the fleet performance dashboard may additionally indicate the entity fleet information for the entity. The entity fleet information may include an overall count of vehicles associated (e.g., including vehicles associated with any vehicle category), a current count of electric vehicles (e.g., including vehicles associated with any electric vehicle category), a current count of non-electric vehicles (e.g., including vehicles not associated with an electric vehicle category), a vehicle usage (e.g., catering, delivery, home services, construction, etc.), a vehicle location, an ownership status (e.g., leased or owned), and/or the like.

The fleet performance dashboard may allow users to change the granularity of the view for a given entity fleet. For example, the fleet performance dashboard may allow a user to view a particular vehicle corresponding to a vehicle identifier, a vehicle category that may provide a summary of all vehicles and/or display all vehicles corresponding to a particular vehicle type or category, or an overall entity fleet that may include a summary of all vehicles and/or display all vehicles included in the entity fleet. Thus, an end user may use the fleet performance dashboard to gain insight into the current composition and metrics of the entity fleet.

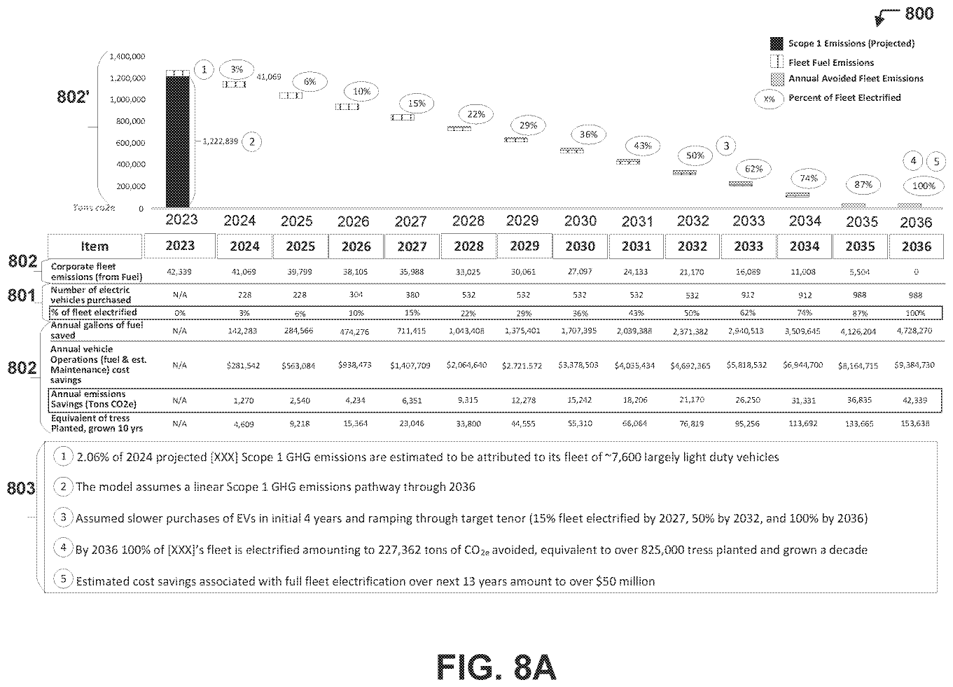

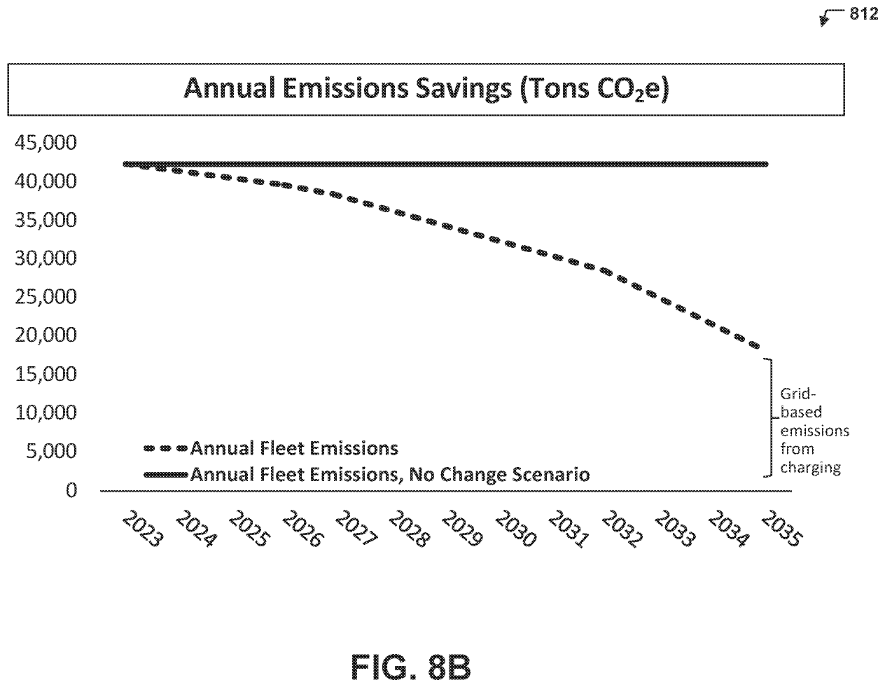

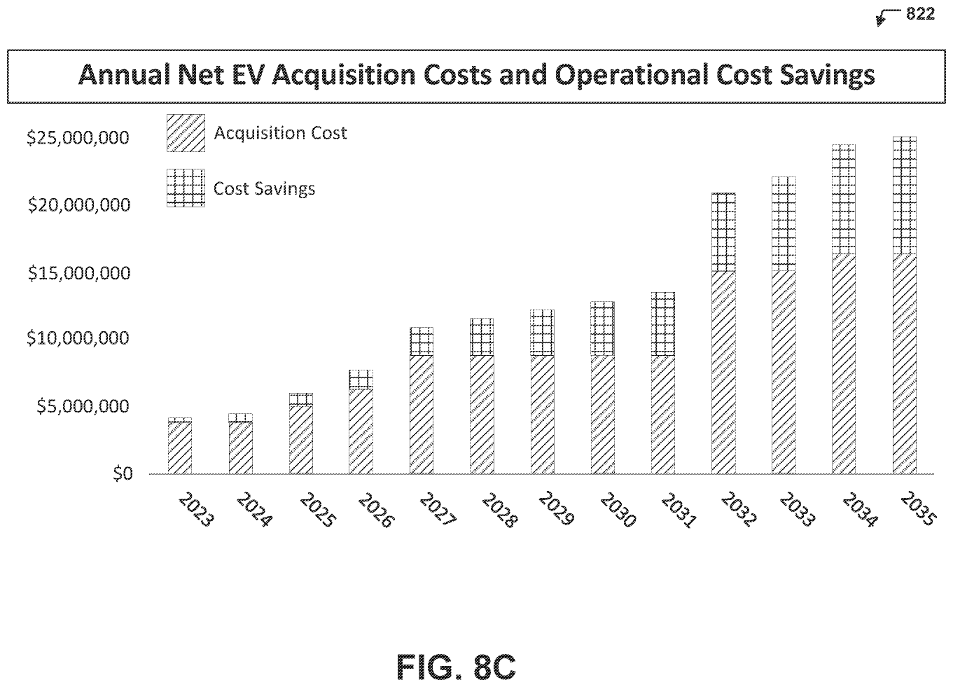

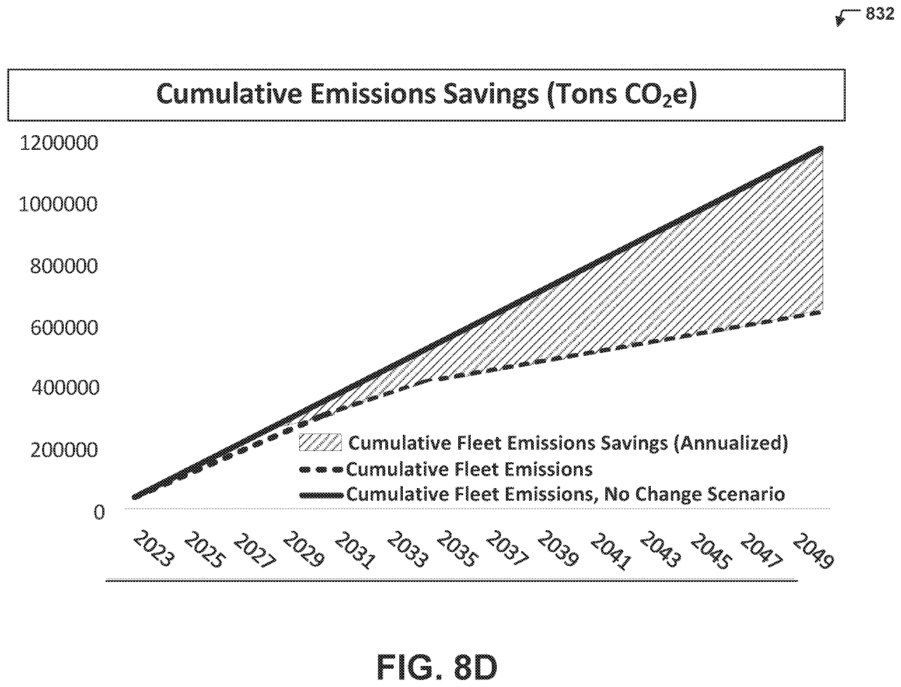

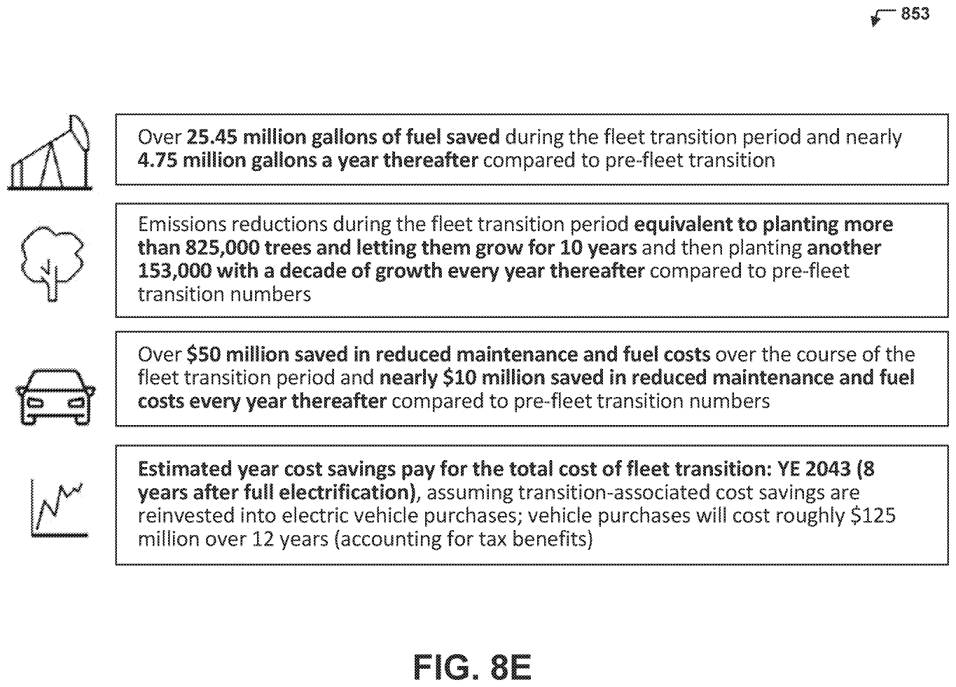

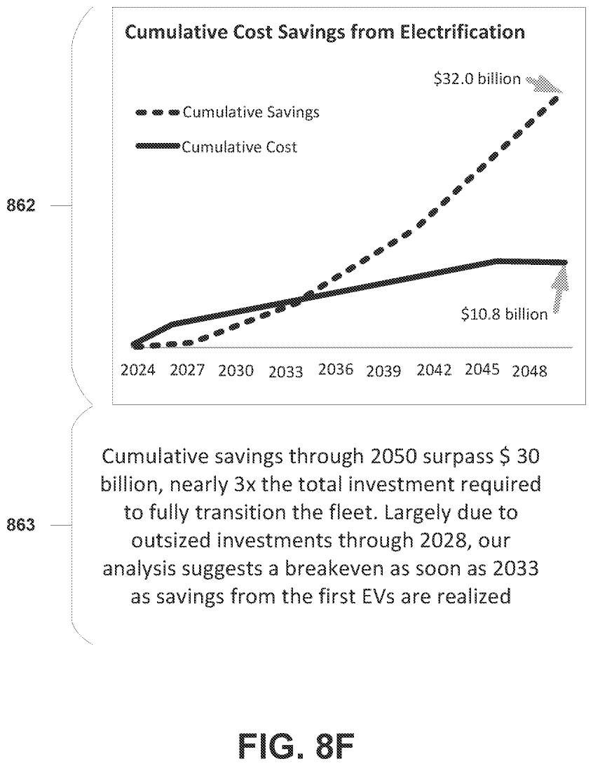

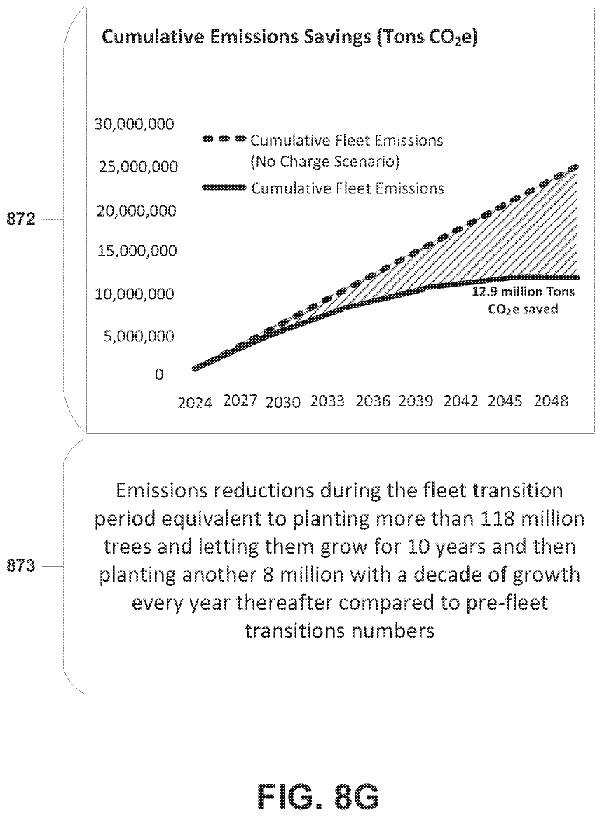

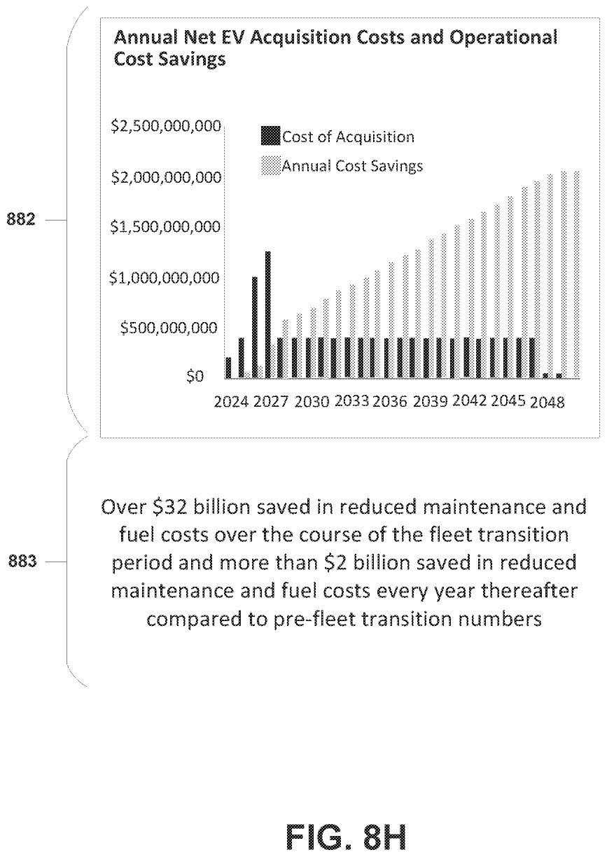

Turning to FIGS. 8A-8H, GUIs are provided that illustrate example fleet transition climate impact reports. As noted previously, a user may interact with the entity analysis system 102 by directly engaging with communications hardware 206 of an apparatus 200. In such an embodiment, the GUIs shown in FIGS. 8A-8E may be displayed to a user by the apparatus 200. Alternatively, a user may interact with the entity analysis system 102 using a separate user device (e.g., any of entity devices 106A-106N and/or any of third-party devices 108A-108N, as shown in FIG. 1), which may communicate with the entity analysis system 102 via communications network 104. In such an embodiment, the GUIs shown in FIGS. 8A-8H may be displayed to the user by the corresponding user device.

As shown by FIG. 8A, a fleet transition climate impact report 800 may provide the user with recommended fleet electrification schedule 801. The recommended fleet electrification schedule 801 may be broken down into recommended fleet electrification events associated with a recommended event time frame. For example, a recommended fleet electrification event shown in FIG. 8A may correspond to a 3% fleet electrification in the year 2024 (e.g., the event time frame). Additionally, the fleet transition climate impact report 800 further includes one or more projection metrics 802 determined for one or more recommended fleet electrification events. For example, a projection metric may be indicative of a value for corresponding metric categories such as corporate fleet emission, annual gallons of fuel saved, annual vehicle operation cost savings, annual vehicle acquisition costs, an annual emissions savings, a cumulative emissions savings, an equivalent number of trees planted, etc., for a given recommended electrification event of a particular time frame. Additionally, the projection metrics 802 may be represented in graphical form as shown by projection metric graph 802′, which graphically illustrates predicted carbon emissions (e.g., projection metrics) for a carbon emissions metric category determined for the recommended fleet electrification events. Furthermore, the fleet transition climate impact report 800 further includes one or more insights 803 determined based on the one or more projection metrics. The one or more insights 803 may provide an explanation of the one or more projection metrics and/or an inferred cause for the projection metrics. FIG. 8E illustrates another example of one or more insights 813 included in the fleet transition climate impact report.

FIG. 8B illustrates another example of projection metrics represented in graphical form. In particular, FIG. 8B includes projection metric graph 812, which graphically illustrates predicted annual emissions savings (e.g., projection metrics) for an annual emissions savings metric category determined for the recommended fleet electrification events.

FIG. 8C illustrates another example of projection metrics represented in graphical form. In particular, FIG. 8C includes projection metric graph 822, which graphically illustrates predicted annual vehicle acquisition costs and vehicle operational cost savings (e.g., projection metrics) for an annual acquisition cost metric category and operational cost metric category, respectively, determined for the recommended fleet electrification events.

FIG. 8D illustrates another example of projection metrics represented in graphical form. In particular, FIG. 8D includes projection metric graph 832, which graphically illustrates predicted cumulative emissions savings (e.g., projection metrics) for an emissions savings metric category determined for the recommended fleet electrification events.

FIG. 8F illustrates another example of projection metrics represented in graphical form as well as one or more insights for the projection metrics. In particular, FIG. 8F includes projection metric graph 862, which graphically illustrates predicted cumulative cost savings (e.g., projection metrics) for a cost savings metric category determined for the recommended fleet electrification events. The one or more insights 863 provide an explanation of the projection metrics 862 as well as an inferred cause for the projection metrics.

FIG. 8G illustrates another example of projection metrics represented in graphical form as well as one or more insights for the projection metrics. In particular, FIG. 8G includes projection metric graph 872, which graphically illustrates predicted cumulative emissions savings (e.g., projection metrics) for a cumulative emissions savings category determined for the recommended fleet electrification events. The one or more insights 873 provide an explanation of the projection metrics 872 as well as an inferred cause for the projection metrics.

FIG. 8H illustrates another example of projection metrics represented in graphical form as well as one or more insights for the projection metrics. In particular, FIG. 8G includes projection metric graph 882, which graphically illustrates predicted annual net electric vehicle acquisition and operational cost savings (e.g., projection metrics) for an annual cost of vehicle acquisition metric category and operational cost savings metric category determined for the recommended fleet electrification events. The one or more insights 883 provide an explanation of the projection metrics 882 as well as an inferred cause for the projection metrics.

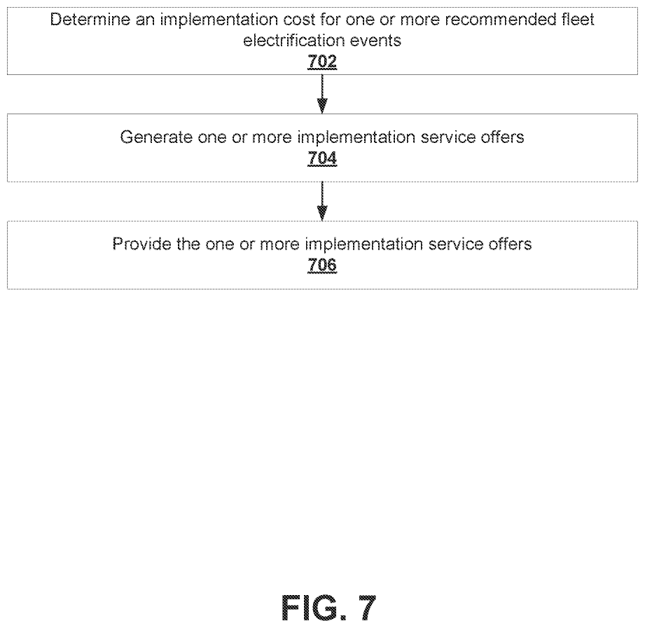

Turning next to FIG. 7, example operations are shown for generating and providing implementation service offers. In some embodiments, the fleet transition climate impact report request may indicate that a user or entity associated with the fleet transition climate impact report request has additionally opted into service offers. Alternatively, communications hardware 206 may receive a separate implementation service offer request from an entity, such as via entity devices 106A-106N. Thus, apparatus 200 may perform the operations of FIG. 7, as described below, to provide the requesting entity one or more implementation service offers. The generated implementation service offers may offer financial assistance or other resource assistance to aid the entity with switching or replacing existing vehicles with electric vehicles. Thus, the implementation service offers may provide the entity with the resources required to achieve the one or more target fleet electrification goals for a given recommended fleet electrification event.

As shown by operation 702, the apparatus 200 includes means, such as processor 202, memory 204, communications hardware 206, entity improvement circuitry 214, and/or the like, for determining an implementation cost for one or more recommended fleet electrification events. Once the fleet electrification circuitry 212 has generated one or more recommended fleet electrification events, the entity improvement circuitry 214 may evaluate one or more of the recommended fleet electrification events to determine an implementation cost for said recommended fleet electrification event. An implementation cost is an estimate of the financial resources required for the entity to achieve one or more target fleet electrification goals associated with a given recommended fleet electrification event.

In some embodiments, the entity improvement circuitry 214 may use an estimate model to determine an implementation cost for a given recommended fleet electrification event. The estimate model may be a machine-learning model, such as a neural network, or rules-based model that is configured to process the one or more recommended fleet electrification events and, optionally, the current entity fleet metric set and/or the current vehicle estimate metric set to determine the implementation cost. In some embodiments, the estimate model may also be configured to process the one or more recommended products.

The estimate model may be configured to identify the one or more target fleet electrification goals associated with a recommended fleet electrification event, determine one or more costs associated with achieving each target fleet electrification goal, and sum the associated costs to determine an implementation cost for the recommended fleet electrification event. For example, a recommended fleet electrification event may be associated with a target fleet electrification goal of increasing the total number of electric vehicles within its fleet from 0% to 3% within a one-year span. The estimate model may determine a current overall count of vehicles (e.g., including vehicles associated with any vehicle category), a current count of electric vehicles (e.g., including vehicles associated with an electric vehicle category), a current count of non-electric vehicles (e.g., including vehicles not associated with an electric vehicle category), and/or the like. The estimate model may additionally use the one or more recommended products and associated prices to determine an implementation cost. In some embodiments, the estimate model may determine a similarity between the one or more electrification goals and associated counts (e.g., current overall count of vehicles, current count of electric vehicles, current count of non-electric vehicles) and one or more historical electrification goals and associated counts. The estimate model may then determine an implementation cost for a given recommended fleet electrification event based on the determined similarity.

As shown by operation 704, the apparatus 200 includes means, such as processor 202, memory 204, communications hardware 206, entity improvement circuitry 214, and/or the like, for generating one or more implementation service offers. An implementation service offer may include a financial instrument offer with a particular value. For example, a financial instrument offer may be a fixed-rate loan, an adjustable-rate loan, a construction loan, a refinancing loan, etc. The value of the financial instrument offer may cover at least a portion of the one or more implementation costs determined in operation 702. In some embodiments, the entity improvement circuitry 214 may determine the financial instrument offer and/or value of the financial instrument offer based on currently available products or services offered by an entity associated with apparatus 200, which may be a financial institution. The currently available products or services may be associated with various qualifying criteria as well as financial limits such that the entity improvement circuitry 214 may evaluate the entity to determine whether the entity qualifies for a given financial product. Additionally, the entity improvement circuitry 214 may determine which products and/or services are associated with limits that cover the one or more implementation costs. In some embodiments, the entity improvement circuitry 214 may include each qualifying financial instrument in the one or more implementation service offers. In some embodiments, the entity improvement circuitry 214 may provide an indication of each qualifying financial instrument to an authorized user associated with apparatus 200 and receive feedback from the authorized user indicative of which financial instruments to include in the one or more implementation service offers. In some embodiments, the entity may not qualify for any financial products such that the implementation service offer is not generated for a particular recommended fleet electrification event.

As shown by operation 706, the apparatus 200 includes means, such as processor 202, memory 204, communications hardware 206, and/or the like, for providing the one or more implementation service offers. In some embodiments, the one or more implementation service offers may be included in the fleet transition climate impact report. For example, if the fleet transition climate impact report was indicative that a user or entity associated with the fleet transition climate impact report request has opted into service offers, the one or more implementation service offers may be included in the fleet transition climate impact report. Alternatively, communications hardware 206 may receive a separate implementation service offer request from an entity, such as via entity devices 106A-106N. In this instance, the communications hardware 206 may provide the one or more implementation service offers in a separate implementation service offer response.

In some embodiments, the one or more implementation service offers may be determined for each recommended fleet electrification event included in the recommended fleet electrification schedule. As such, each recommended fleet electrification event in the recommended fleet electrification schedule may be individually evaluated to determine an implementation service offer. It will be appreciated that although operations 702-706 may be performed for each recommended fleet electrification event, in some embodiments, an implementation service offer may be generated for two or more recommended fleet electrification events simultaneously, such as by using parallel processing. As such, the computational run time associated with generating the one or more implantation service offers may be reduced. This may allow for high-performance scaling of the process such that a large volume of implementation service offers may be feasibly generated within a desired time frame.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software, including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose hardware-based computing devices that perform the specified functions, or combinations of special-purpose hardware and software instructions.

Conclusion

As described above, example embodiments provide methods and apparatuses that enable improved methods for optimizing an entity vehicle fleet transition to electric vehicles to reduce their emission profile. In particular, example embodiments provide for the generation and provision of a fleet transition climate impact report that may provide users with an indication of a recommended fleet electrification schedule. As such, end users may review the fleet transition climate impact report to gain a better understanding when to transition vehicles to electric vehicles and how many vehicles to transition. Additionally, the fleet transition climate impact report may include projection metrics and/or insights that may aid the user with understanding contributing factors that determined the recommended fleet electrification events included in the recommended fleet electrification schedule.

Example embodiments also allow for the generation of additional information, such as recommended products and implementation service offers, which may each provide additional insights into the entity as a whole, as well as the individual entity assets that were not traditionally available. Thus, users may be provided with specific opportunities to improve their emissions profile. Furthermore, example embodiments described herein may leverage the use of multiple sets of computing infrastructure to enable a reduction in the runtime for the various described operations, and in some implementations allow the evaluation of multiple scenarios at once, which can enhance overall operational planning processes and ensure that the output information is up-to-date and accurate.

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating a fleet transition climate impact report for an entity, the method comprising:
receiving, by communications hardware, a fleet transition climate impact report request, wherein (a) the fleet transition climate impact report request comprises one or more emission target goals, and (b) each emission target goal is associated with a goal completion date;
determining, by entity analysis circuitry, a current entity fleet metric set for the entity;
determining, by fleet analysis circuitry, a current vehicle estimate metric set;
generating, by fleet electrification circuitry and based on (a) the current entity fleet metric set, (b) the current vehicle estimate metric set, and (c) the one or more emission target goals, a recommended fleet electrification schedule, wherein (i) the recommended fleet electrification schedule comprises one or more recommended fleet electrification events, (ii) each recommended fleet electrification event is associated with a recommended event time frame, and (iii) each recommended fleet electrification event is associated with one or more target fleet electrification goals;
generating, by fleet electrification circuitry, the fleet transition climate impact report, wherein the fleet transition climate impact report comprises the recommended fleet electrification schedule; and
providing, by the communications hardware, the fleet transition climate impact report.

2. The method of claim 1, further comprising, for one or more recommended fleet electrification events:
determining, by the fleet electrification circuitry and based on the current entity fleet metric set and a target fleet electrification goal associated with the recommended fleet electrification event, one or more projection metrics, wherein (a) each projection metric corresponds to a metric category, and (b) each projection metric is indicative of a predicted value for the metric category in an instance in which the one or more target fleet electrification goals associated with a recommended fleet electrification event are achieved.

3. The method of claim 1, further comprising:
generating, by the fleet electrification circuitry and based on the one or more recommended fleet electrification events, one or more insights, wherein (a) each insight provides one or more of (i) an explanation of one or more of the one or more recommended fleet electrifications events, or (ii) an inferred cause for a target fleet electrification goal or recommended event time frame associated with a recommended fleet electrification event; and
(b) the fleet transition climate impact report further comprises the one or more insights.

4. The method of claim 1, wherein a target fleet electrification goal corresponds to a particular percentage or amount of an entity's fleet corresponding to an electric vehicle category.

5. The method of claim 1, further comprising:
receiving, by communications hardware, an entity fleet report;
identifying, by the entity analysis circuitry and based on the entity fleet report, one or more vehicles associated with the entity; and
determining, by the entity analysis circuitry, a vehicle category for each vehicle of the one or more identified vehicles,
wherein the one or more identified vehicles are included in the current entity fleet metric set.

6. The method of claim 1, further comprising:
extracting, by fleet analysis circuitry, vehicle information from one or more data sources; and
determining, by the fleet analysis circuitry and based on the vehicle information, one or more vehicle parameter estimates, wherein a vehicle parameter estimate corresponds to a particular vehicle category,
wherein the one or more vehicle parameter estimates are included in the current vehicle estimate metric set.

7. The method of claim 6, further comprising:
receiving, by communications hardware, an entity fleet report, wherein determining the one or more vehicle parameter estimates is further based on the entity fleet report.

8. The method of claim 1, further comprising, for one or more recommended fleet electrification events:
determining, by the fleet electrification circuitry, one or more recommended products, wherein (a) the one or more recommended products are determined to fit criteria necessary to satisfy a target fleet electrification goal associated with the recommended fleet electrification event, and (b) the fleet transition climate impact report further comprises the one or more recommended products.

9. The method of claim 1, further comprising:
determining, by entity improvement circuitry, an implementation cost estimate for one or more of the one or more recommended fleet electrification events;
generating, by the entity improvement circuitry, one or more implementation service offers, wherein an implementation service offer comprises a financial instrument offer and a value of the financial instrument offer covers at least a portion of the implementation cost estimate; and
providing, by communications hardware, the one or more implementation service offers.

10. The method of claim 1, further comprising:
determining, by prediction circuitry and based on the recommended fleet electrification schedule, one or more predicted inventory events, wherein (a) a predicted inventory event is associated with a particular vehicle category, and (b) each inventory event is associated with an event time frame,
wherein generating the recommended fleet electrification schedule is further based on the one or more predicted inventory events.

11. The method of claim 10, further comprising:
determining, by the prediction circuitry, one or more predicted fleet electrification external events, wherein (a) a predicted fleet electrification external event corresponds to an external entity, and (b) each predicted fleet electrification external event is associated with a predicted event time frame; and
determining, by the prediction circuitry and based on the one or more predicted fleet electrification external events, one or more predicted inventory values for a vehicle category, wherein (a) a predicted inventory value is indicative of a predicted availability of vehicles corresponding to a particular vehicle category, and (b) a predicted inventory value is associated with a time frame,
wherein determining the one or more predicted inventory events is further based on the one or more predicted inventory values.

12. An apparatus for generating a fleet transition climate impact report for an entity, the apparatus comprising:
communications hardware configured to receive an fleet transition climate impact report request, wherein (a) the fleet transition climate impact report request comprises one or more emission target goals, and (b) each emission target goal is associated with a goal completion date;
entity analysis circuitry configured to determine a current entity fleet metric set for the entity;
fleet analysis circuitry configured to determine a current vehicle estimate metric set;
fleet electrification circuitry configured to:
generate, based on (a) the current entity fleet metric set, (b) the current vehicle estimate metric set, and (c) the one or more emission target goals, a recommended fleet electrification schedule, wherein (i) the recommended fleet electrification schedule comprises one or more recommended fleet electrification events, (ii) each recommended fleet electrification event is associated with a recommended event time frame, and (iii) each recommended fleet electrification event is associated with one or more target fleet electrification goals, and
generate the fleet transition climate impact report, wherein the fleet transition climate impact report comprises the recommended fleet electrification schedule; and
wherein the communications hardware is further configured to provide the fleet transition climate impact report.

13. The apparatus of claim 12, wherein the fleet electrification circuitry is further configured to, for one or more recommended fleet electrification events:
determine, based on the current entity fleet metric set and a target fleet electrification goal associated with the recommended fleet electrification event, one or more projection metrics, wherein (a) each projection metric corresponds to a metric category, and (b) each projection metric is indicative of a predicted value for the metric category in an instance in which the one or more target fleet electrification goals associated with a recommended fleet electrification event are achieved.

14. The apparatus of claim 12, wherein the fleet electrification circuitry is further configured to:
generate, based on the one or more recommended fleet electrification events, one or more insights, wherein (a) each insight provides one or more of (i) an explanation of one or more of the recommended fleet electrifications events, or (ii) an inferred cause for a target fleet electrification goal or recommended event time frame associated with a recommended fleet electrification event; and (b) the fleet transition climate impact report further comprises the one or more insights.

15. The apparatus of claim 12, wherein a target fleet electrification goal corresponds to a particular percentage or amount of an entity's fleet corresponding to an electric vehicle category.

16. The apparatus of claim 12, wherein the communications hardware is further configured to receive an entity fleet report, and
wherein the entity analysis circuitry is further configured to:
identify, based on the entity fleet report, one or more vehicles associated with the entity, and
determine a vehicle category for each vehicle of the one or more identified vehicles, wherein the one or more identified vehicles are included in the current entity fleet metric set.

17. The apparatus of claim 12, wherein the fleet analysis circuitry is further configured to:
extract vehicle information from one or more data sources; and
determine, based on the vehicle information, one or more vehicle parameter estimates, wherein a vehicle parameter estimate corresponds to a particular vehicle category,
wherein the one or more vehicle parameter estimates are included in the current vehicle estimate metric set.

18. The apparatus of claim 17, wherein the communications hardware is further configured to:
receive an entity fleet report, wherein determining the one or more vehicle parameter estimates is further based on the entity fleet report.

19. The apparatus of claim 12, wherein the fleet electrification circuitry is further configured to, for one or more recommended fleet electrification events:
determine one or more recommended products, wherein (a) the one or more recommended products are determined to fit criteria necessary to satisfy a target fleet electrification goal associated with the recommended fleet electrification event, and (b) the fleet transition climate impact report further comprises the one or more recommended products.

20. A computer program product for generating an fleet transition climate impact report for an entity, the computer program product comprising at least one non-transitory computer-readable storage medium storing software instructions that, when executed, cause an apparatus to:
receive an fleet transition climate impact report request, wherein (a) the fleet transition climate impact report request comprises one or more emission target goals, and (b) each emission target goal is associated with a goal completion date;
determine a current entity fleet metric set for the entity;
determine a current vehicle estimate metric set;
generate, based on (a) the current entity fleet metric set, (b) the current vehicle estimate metric set, and (c) the one or more emission target goals, a recommended fleet electrification schedule, wherein (i) the recommended fleet electrification schedule comprises one or more recommended fleet electrification events, (ii) each recommended fleet electrification event is associated with a recommended event time frame, and (iii) each recommended fleet electrification event is associated with one or more target fleet electrification goals;
generate the fleet transition climate impact report, wherein the fleet transition climate impact report comprises the recommended fleet electrification schedule; and
provide the fleet transition climate impact report.
